(19) United States
(12) Patent Application Publication
(10) Pub. No.: US 2026/0033514 A1
(43) Pub. Date: Feb. 5, 2026

(54) PREPARATION OF SUNFLOWER PROTEIN PRODUCTS ("871")

(71) Applicant: Burcon Nutrascience (MB) Corp., Winnipeg (CA)

(72) Inventors: Martin SCHWEIZER, Winnipeg (CA); Edwin CATIPON, Winnipeg (CA)

(21) Appl. No.: 18/998,691

(22) PCT Filed: Jul. 24, 2023
(86) PCT No.: PCT/CA2023/050986

§ 371 Date: Jan. 27, 2025

Related U.S. Application Data
(60) Provisional application No. 63/392,211, filed on Jul. 26, 2022.

(51) Int. Cl. A23J 3/14; A23J 1/14; A23K 10/30; A23K 20/147; A23L 2/66; A23L 33/185

(52) U.S. Cl. CPC A23J 3/14; A23J 1/14; A23K 10/30; A23K 20/147; A23L 2/66; A23L 33/185

(57) ABSTRACT

Process for preparing a sunflower protein product with a protein content of greater than 60 wt % (N×6.25) on a dry weight basis, said process having three essential steps, performed in the following order: a) solubilization of a sunflower protein source into an aqueous phase and a residual solid phase, b) separating the aqueous phase from the residual solid phase, and c) acidifying the separated aqueous phase to a pH between 1.5 and 5.

### RELATED APPLICATIONS

The present application claims priority to U.S. provisional patent application 63/392,211 filed Jul. 26, 2022 herein incorporated by reference in its entirety.

### FIELD

The present disclosure relates to novel and inventive sunflower protein products and to novel and inventive methods of preparing sunflower protein products.

### SUMMARY

The present disclosure relates to novel and inventive sunflower products, and novel and inventive processes for the preparation thereof, wherein an acidified aqueous sunflower protein solution is prepared and subsequently processed without a separation step to fractionate soluble and insoluble protein species. Eliminating the separation step and processing the material as one stream rather than two is advantageous at least in that the process is simpler and more economical.

In one embodiment, the present disclosure provides for a process for preparing a sunflower protein product from a sunflower protein source, the sunflower protein product having a protein content of greater than 60 wt % (N×6.25) d.b, the process comprising
a) extracting sunflower protein from a sunflower protein source to cause solubilization of the sunflower protein from the sunflower protein source to produce an aqueous phase and a residual sunflower protein source;
b) separating the aqueous phase from the residual sunflower protein source to produce an aqueous sunflower protein solution and a separated residual sunflower protein source
c) optionally defatting the separated aqueous sunflower protein solution to at least partially remove fat from the separated aqueous sunflower protein solution;
d) adjusting the pH of the aqueous sunflower protein solution to an acidic value in the range of about pH 1.5 to about pH 5.0 to provide an acidified aqueous sunflower protein solution;
e) optionally concentrating the acidified aqueous sunflower protein solution to provide a concentrated sunflower protein solution having a protein concentration of about 5 to about 30 wt %;
f) optionally diafiltering the concentrated acidified sunflower protein solution using water as the diafiltration solution OR diafiltering the acidified aqueous sunflower protein solution using water prior to concentration or diafiltering the partially concentrated aqueous acidified sunflower protein solution using water;
g) optionally drying the acidified aqueous sunflower protein solution (d) or optionally concentrated and/or diafiltered sunflower protein solution ((e) or (f)) to provide a sunflower protein product;
wherein steps e) and f) may optionally be carried out simultaneously.

In another embodiment of the process or processes outlined above, the process further comprises:
treating the aqueous sunflower protein solution with an anti-foamer, such as any suitable food-grade, non-silicone based anti-foamer, to reduce the volume of foam formed upon further processing, and wherein the anti-foamer is optionally added during the extraction step a).

In another embodiment of the process or processes outlined above, the quantity of anti-foamer employed is generally greater than about 0.0003% w/v.

In another embodiment of the process or processes outlined above, the process further comprises:
treating the aqueous sunflower protein solution with an adsorbent, such as granulated activated carbon, to remove colour and/or odour compounds.

In another embodiment of the process or processes outlined above, separation comprises centrifugation and/or filtration optionally with a decanter centrifuge and a disc stack centrifuge.

In another embodiment of the process or processes outlined above, defatting of the separated aqueous sunflower protein solution is achieved by centrifugation and/or filtration.

In another embodiment of the process or processes outlined above, defatting comprises the use of a three-phase centrifuge, such as a three-phase separator, for the simultaneous separation of fat and residual solids from the protein solution, and wherein the three-phase centrifuge is optionally used potentially instead of or in addition to the separation steps defined above.

In another embodiment of the process or processes outlined above, the residual solids captured by the three phase centrifuge are added back to the protein solution for further processing.

In another embodiment of the process or processes outlined above, solubilization from the sunflower protein source is effected using water having different levels of purity such as tap water or reverse osmosis (RO) purified water.

In another embodiment of the process or processes outlined above, the pH of the extraction may be the natural pH of the combination of the water and the sunflower protein source, or the pH of the extraction may be adjusted up to any value between the natural pH and about 8.5, or the pH may be adjusted within the range of about 6.8 to about 8.0, or the pH may be adjusted to about 6.8 to about 7.5.

In another embodiment of the process or processes outlined above, food grade sodium hydroxide, potassium hydroxide or any other conventional food grade alkali and combinations thereof are added to the water to adjust the pH of the extraction.

In another embodiment of the process or processes outlined above, solubilization of the protein is effected at a temperature of from about 1° C. to about 100° C., preferably about 15° C. to about 65° C., more preferably about 50° C. to about 60° C., preferably accompanied by agitation.

In another embodiment of the process or processes outlined above, the solubilization time is about 1 to about 60 minutes, preferably about 10 to about 30 minutes.

In another embodiment of the process or processes outlined above, the concentration of the sunflower protein source in the water during the extraction step is selected from the group consisting of about 5 to about 20% w/v and about 5 to about 15% w/v.

In another embodiment of the process or processes outlined above, the aqueous phase resulting from the extraction step generally has a protein concentration of about 0.5 to about 5 wt %, preferably about 1 to about 5 wt %.

In another embodiment of the process or processes outlined above, the water of extraction may contain an antioxidant, such as ascorbic acid optionally in an amount of from about 0.01 to about 1 wt % of the solution, preferably about 0.05 to about 0.15 wt %, more preferably about 0.05 to about 0.10 wt %.

In another embodiment of the process or processes outlined above, the separation step b) is conducted at the same temperature as the extraction step or at any temperature within the range of about 1° C. to about 100° C., preferably about 15° C. to about 65° C., more preferably about 50° C. to about 60° C.

In another embodiment of the process or processes outlined above, the separated sunflower protein solution is adjusted to a pH of about 1.5 to about 4.0, preferably about 2.0 to about 3.0, in step (d).

In another embodiment of the process or processes outlined above, the separated sunflower protein solution is adjusted in pH in step (d) by the addition of any food grade acid such as hydrochloric acid solution, phosphoric acid solution, or citric acid solution.

In another embodiment of the process or processes outlined above, the acidified aqueous protein solution following acidification step (d) is subjected to a heat treatment step.

In an embodiment of the process or processes outlined above, the heat treatment step is effected to potentially aid to inactivate heat-labile anti-nutritional factors.

In an embodiment of the process or processes outlined above, the anti-nutritional factors are heat-labile trypsin inhibitors.

In another embodiment of the process or processes outlined above, the heat treatment step is effected to pasteurize the acidified aqueous protein solution.

In another embodiment of the process or processes outlined above, the heat treatment is effected at a temperature of about 70° C. to about 160° C. for about 10 seconds to about 60 minutes.

In another embodiment of the process or processes outlined above, the heat treatment is effected at a temperature of about 80° C. to about 120° C. for about 10 seconds to about 5 minutes.

In another embodiment of the process or processes outlined above, the heat treatment is effected at a temperature of about 85° C. to about 95° C. for about 30 seconds to about 5 minutes.

In another embodiment of the process or processes outlined above, the heat treated acidified sunflower protein solution is cooled to a temperature of about 2° C. to about 65° C.

In another embodiment of the process or processes outlined above, the heat treated acidified sunflower protein solution is cooled to a temperature of about 50° C. to about 60° C.

In another embodiment of the process or processes outlined above, the acidified aqueous sunflower protein solution is dried to provide a sunflower protein product having a protein content of at least about 60 wt % (N×6.25) d.b.

In another embodiment of the process or processes outlined above the acidified sunflower protein solution is optionally concentrated in (e) to a protein concentration of about 5 to about 20 wt %, preferably about 10 to about 20 wt %.

In another embodiment of the process or processes outlined above, the concentration step e) is effected by selective membrane technique, such as ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, more preferably about 10,000 to about 100,000 daltons.

In another embodiment of the process or processes outlined above, the diafiltration step f) is effected using water as the diafiltration solution without any pH adjustment or the water is adjusted with any food grade acid to a pH down to that of the optionally concentrated sunflower protein solution.

In another embodiment of the process or processes outlined above, the diafiltration may be done in stages using water at different pH values, such as initial volumes of diafiltration using water adjusted to the pH of the protein solution followed by additional volumes of diafiltration using water without pH adjusting agent.

In another embodiment of the process or processes outlined above, diafiltration is effected using from about 0.5 to about 40 volumes of diafiltration solution, preferably about 2 to about 25 volumes of diafiltration solution, more preferably about 2 to about 5 volumes of diafiltration solution.

In another embodiment of the process or processes outlined above, diafiltration is effected using the same membrane as for the concentration step e) or the diafiltration step f) is effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons.

In another embodiment of the process or processes outlined above, the concentration step and/or the diafiltration step are effected in such a manner that the sunflower protein product subsequently recovered contains at least about 60 wt %, at least about 65 wt %, at least about 70 wt %, at least about 75 wt %, at least about 80 wt %, at least about 85 wt %, at least about 90 wt %, or greater than about 95 wt % protein (N×6.25) d.b.

In another embodiment of the process or processes outlined above, the diafiltration water comprises an antioxidant, such as ascorbic acid, optionally in an amount of from about 0.01 to about 1 wt %, preferably about 0.05 to about 0.15 wt %, more preferably about 0.05 to about 0.10 wt %.

In another embodiment of the process or processes outlined above, the optional concentration step e) and the optional diafiltration step f) are effected at generally about 2° C. to about 65° C., preferably about 50° C. to about 60° C.

In another embodiment of the process or processes outlined above, the optionally concentrated and optionally diafiltered protein solution is subject to a further defatting step.

In another embodiment of the process or processes outlined above, the optionally concentrated and optionally diafiltered protein solution are treated with an adsorbent, such as granulated activated carbon, to remove colour and/or odour compounds.

In another embodiment of the process or processes outlined above, step e) and/or f) are carried out and the partially concentrated, concentrated and/or diafiltered acidified sunflower protein solution is subjected to a heat treatment step.

In another embodiment of the process or processes outlined above, the heat treatment step is effected to potentially aid to inactivate heat-labile anti-nutritional factors.

In another embodiment of the process or processes outlined above, the anti-nutritional factors are heat-labile trypsin inhibitors.

In another embodiment of the process or processes outlined above, the heat treatment step is effected to pasteurize the partially concentrated, concentrated and/or diafiltered acidified sunflower protein solution.

In another embodiment of the process or processes outlined above, the heat treatment is effected at a temperature of about 70° C. to about 160° C. for about 10 seconds to about 60 minutes.

In another embodiment of the process or processes outlined above, the heat treatment is effected at a temperature of about 80° C. to about 120° C. for about 10 seconds to about 5 minutes.

In another embodiment of the process or processes outlined above, the heat treatment is effected at a temperature of about 85° C. to about 95° C. for about 30 seconds to about 5 minutes.

In another embodiment of the process or processes outlined above, the heat treated sunflower protein solution is cooled to a temperature of about 2° C. to about 65° C.

In another embodiment of the process or processes outlined above, the heat treated sunflower protein solution is cooled to a temperature of about 50° C. to about 60° C.

In another embodiment of the process or processes outlined above, the concentration and/or diafiltration steps are operated in a manner favourable for removal of trypsin inhibitors in the permeate, optionally by using a membrane of larger molecular weight cut-off, such as 30,000 to 1,000,000 Da, operating the membrane at elevated temperatures, such as about 30° C. to about 65° C., preferably about 50° C. to about 60° C. and employing greater volumes of diafiltration medium, such as 10 to 40 volumes.

In another embodiment of the process or processes outlined above, the aqueous sunflower protein solution is exposed to reducing agents that at least partially disrupt or rearrange the disulfide bonds of the inhibitors, such as sodium sulfite, cysteine or N-acetylcysteine.

In another embodiment of the process or processes outlined above, the optionally concentrated and optionally diafiltered protein solution is pasteurized prior to optional drying or further processing and wherein pasteurization optionally comprises heating the optionally concentrated and optionally diafiltered sunflower protein solution to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° C. to about 35° C.

In another embodiment of the process or processes outlined above, the optionally concentrated, optionally diafiltered and optionally pasteurized sunflower protein solution is subject to drying step g) by any conventional means such as spray drying or freeze drying to provide a sunflower protein product having a protein content of at least about 60 wt %, at least about 65 wt %, at least about 70 wt %, at least about 75 wt %, at least about 80 wt %, at least about 85 wt %, at least about 90 wt %, or greater than about 95 wt % protein (N×6.25) d.b.

In another embodiment of the process or processes outlined above, step e) and/or f) are carried out and said concentrated and/or diafiltered acidified sunflower protein solution is subjected to drying step (g) to provide a sunflower protein product having a protein content of at least about 60 wt %, at least about 65 wt %, at least about 70 wt %, at least about 75 wt %, at least about 80 wt %, at least about 85 wt %, at least about 90 wt %, or greater than about 95 wt % protein (N×6.25) d.b.

In another embodiment of the process or processes outlined above, the pH of the optionally concentrated and optionally diafiltered acidified sunflower protein solution is raised to a value selected from the group consisting of less than about 8.0, about 6.0 to about 8.0 and about 6.5 to about 7.5, to produce a pH adjusted sunflower protein solution, prior to optional drying step (g).

In another embodiment of the process or processes outlined above, the pH adjusted sunflower protein solution is further membrane processed such as concentrated and/or diafiltered prior to optional drying step (g).

In another embodiment of the process or processes outlined above, a food grade sodium hydroxide, potassium hydroxide or any other conventional food grade alkali and combinations thereof are added to the optionally concentrated and optionally diafiltered acidified sunflower protein solution to raise the pH.

In another embodiment of the process or processes outlined above, the optionally concentrated and optionally diafiltered acidified sunflower protein solution, the pH adjusted sunflower protein solution or the membrane processed pH adjusted sunflower protein solution may be jet cooked to a temperature of about 110° C. to about 150° C. for a time of about 10 seconds to about 1 minute, preferably about 140° C. to about 145° C. for about 40 to about 50 seconds, prior to drying step (g).

In another embodiment of the process or processes outlined above, the pH adjusted sunflower protein solution or further concentrated and/or diafiltered protein pH adjusted sunflower protein solution is pasteurized prior to optional drying and pasteurization optionally comprises heating the sunflower protein solution to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° C. to about 35° C.

In another embodiment of the process or processes outlined above, the process or processes further comprise the steps of
bi) optionally further processing the separated residual sunflower protein source obtained in step b), such as to recover residual protein; or
bii) optionally re-extracting the separated residual sunflower protein source obtained in step b) with fresh water to recover residual protein and separating the re-extraction protein solution from the residual sunflower protein source and optionally combining the re-extraction protein solution with the aqueous sunflower protein solution for further processing.

In another embodiment of the process or processes outlined above, step a) is carried out using a counter-current extraction procedure.

In another embodiment of the process or processes outlined above, the finer residual solids are captured separately from the bulk of the separated residual sunflower protein source in step b), optionally by the disc stack centrifuge, are optionally diluted with water, optionally RO water, then optionally dried to form a sunflower protein product having a protein content of at least about 45 wt % (N×6.25) d.b., at least about 50 wt % (N×6.25) d.b., at least about 55 wt % (N×6.25) d.b., or at least about 60 wt % (N×6.25) d.b.

In another embodiment of the process or processes outlined above, the pH of the optionally diluted finer residual solids is raised to a value between about 6.0 and about 8.0, by any conventional means such as by the addition of sodium hydroxide, potassium hydroxide or any other conventional food grade alkali and combinations thereof, or hydrochloric acid, phosphoric acid, citric acid or any other conventional food grade acid and combinations thereof, prior to optional drying to form a sunflower protein product having a protein content of at least about 45 wt % (N×6.25) d.b., at least about 50 wt % (N×6.25) d.b., at least about 55 wt % (N×6.25) d.b., or at least about 60 wt % (N×6.25) d.b.

In another embodiment of the process or processes outlined above, the finer residual solids are washed in order to remove contaminants and improve the purity and flavour of the product, optionally by suspending the solids in between about 1 and about 20 volumes, preferably about 1 to about 10 volumes of wash solution such as water, preferably RO water, and optionally the washing step is conducted at any conventional temperature such as about 15° C. to about 65° C., preferably about 50° C. to about 60° C., and optionally for any conventional length of time, preferably 15 minutes or less. The washed finer residual solids are then separated from the used wash solution by any conventional means such as by centrifugation using a disc stack centrifuge.

In another embodiment of the process or processes outlined above, the used wash solution separated from the washed finer residual solids may be added to the aqueous sunflower protein solution arising from the separation step b) or to the optionally concentrated and optionally diafiltered acidified sunflower protein solution for further processing.

In another embodiment of the process or processes outlined above, the separated used wash solution is defatted before addition to the aqueous sunflower protein solution or optionally concentrated and optionally diafiltered acidified sunflower protein solution.

In another embodiment of the process or processes outlined above, the washed finer residual solids are optionally diluted with water then optionally dried by any conventional means such as spray drying or freeze drying to provide a sunflower protein product having a protein content of at least about 45 wt % (N×6.25) d.b., at least about 50 wt % (N×6.25) d.b., at least about 55 wt % (N×6.25) d.b., at least about 60 wt % (N×6.25) d.b., at least about 65 wt % (N×6.25) d.b., or at least about 70 wt % (N×6.25) d.b.

In another embodiment of the process or processes outlined above, the pH of the optionally diluted washed finer residual solids is adjusted to a value between about 6.0 and about 8.0, by any conventional means such as by the addition of sodium hydroxide, potassium hydroxide or any other conventional food grade alkali and combinations thereof, or hydrochloric acid, phosphoric acid, citric acid or any other conventional food grade acid and combinations thereof, prior to optional drying.

In another embodiment of the process or processes outlined above, the finer residual solids are pH adjusted during the washing step by adjusting the mixture of finer residual solids and wash water to a pH between about 6.0 and about 8.0 using food grade alkali or acid solution, then collecting the solids by centrifugation and optionally diluting and optionally drying the solids.

In another embodiment of the process or processes outlined above, the process or processes further comprise pasteurizing the optionally diluted and optionally pH adjusted finer residual solids or optionally diluted and optionally pH adjusted washed finer residual solids prior to the optional drying step, wherein pasteurization optionally comprises heating to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds.

In another embodiment of the process or processes outlined above, the pasteurized optionally diluted and optionally pH adjusted finer residual solids or optionally diluted and optionally pH adjusted washed finer residual solids is cooled, such as to a temperature of about 20° C. to about 35° C.

In another embodiment of the process or processes outlined above, the coarse residual solids are captured separately from the finer residual solids of the separated residual sunflower protein source in step b), optionally by the decanter centrifuge, are optionally diluted with water, optionally RO water, optionally pasteurized then optionally dried to form a sunflower protein product having a protein content of at least about 25 wt % (N×6.25) d.b., preferably at least about 30, 35, 40, 45, 50 or 55 wt % (N×6.25) d.b., more preferably at least about 60 wt % (N×6.25) d.b.

In another embodiment of the process or processes outlined above, the coarse residual solids are captured separately from the finer residual solids of the separated residual sunflower protein source in step b), the finer residual solids are optionally washed, then the coarse residual solids and the optionally washed finer residual solids are combined for optional dilution with water, optional pasteurization and optional drying to form a sunflower protein product having a protein content of at least about 40 wt % (N×6.25) d.b., preferably at least about 45, 50 or 55 wt % (N×6.25) d.b., more preferably at least about 60 wt % (N×6.25) d.b.

In another embodiment of the process or processes outlined above, the extraction is carried out in a continuous operation or a batch operation.

In a further embodiment, the present disclosure provides for a sunflower protein product having a protein content of at least about 65, at least about 70, at least about 75, at least about 80, at least about 85, at least about 90, or at least about 95 wt % (N×6.25) d.b., which has a protein solubility of less than 30% when measured at pH 4, less than about 20% when measured at pH 5.5 and less than 40% when measured at pH 7.

In a further embodiment of the product or products outlined above, the product has a protein solubility of 4.8-21.3% when measured at pH 4, 3.5-17.6% when measured at pH 5.5 and 7.3-36.6% when measured at pH 7.

In a further embodiment of the product or products outlined above, the product has a protein solubility of 8.1-19.3% when measured at pH 4, 3.5-12.0% when measured at pH 5.5 and 11.8-27.2% when measured at pH 7.

In a further embodiment, the present disclosure provides for a sunflower protein product having a protein content of at least about 65, at least about 70, at least about 75, at least about 80, at least about 85, at least about 90, or at least about 95 wt % (N×6.25) d.b., which has a dry colour L* value of about 52.54 to about 84.18, a dry colour a* value of about −1.99 to about 4.31 and a dry colour b* value of about 11.27 to 21.90.

In a further embodiment of the product or products outlined above, the product has a dry colour L* value of about 80.69 to about 84.18, a dry colour a* value of about −1.05 to about 0.50 and a dry colour b* value of about 11.27 to 17.24.

In a further embodiment of the product or products outlined above, the product has a dry colour L* value of about 80.69 to about 83.40, a dry colour a* value of about −0.24 to about 0.50 and a dry colour b* value of about 11.60 to 14.50.

In a further embodiment, the present disclosure provides for a sunflower protein product having an amino acid profile comprising:

| amino | concentration |
|---|---|
| acid | (mg/g protein) |
| Threonine | about 31.4 to about 44.3 |
| Valine | about 43.3 to about 54.8 |
| Isoleucine | about 36.6 to about 48.2 |
| Leucine | about 54.5 to about 75.5 |
| Tyrosine | about 23.4 to about 36.2 |
| Phenylalanine | about 39.3 to about 61.6 |
| Lysine | about 27.2 to about 41.0 |
| Histidine | about 23.6 to about 33.3 |
| Cysteine | about 14.2 to about 23.4 |
| Methionine | about 16.6 to about 33.1 |
| Tryptophan | about 10.6 to about 12.2 |

In a further embodiment of the product or products outlined above, the product has an amino acid profile comprising:

| amino | concentration |
|---|---|
| acid | (mg/g protein) |
| Threonine | about 31.4 to about 44.3 |
| Valine | about 43.3 to about 54.8 |
| Isoleucine | about 36.6 to about 48.2 |
| Leucine | about 54.5 to about 75.5 |
| Tyrosine | about 25.7 to about 36.2 |
| Phenylalanine | about 46.1 to about 61.6 |
| Lysine | about 27.2 to about 38.0 |
| Histidine | about 23.8 to about 33.3 |
| Cysteine | about 14.2 to about 23.4 |
| Methionine | about 22.9 to about 33.1 |
| Tryptophan | about 10.6 to about 12.2 |

In a further embodiment of the product or products outlined above, the product has an amino acid profile comprising:

| amino | concentration |
|---|---|
| acid | (mg/g protein) |
| Threonine | about 41.6 to about 44.3 |
| Valine | about 52.8 to about 54.8 |
| Isoleucine | about 46.6 to about 48.2 |
| Leucine | about 73.1 to about 75.5 |
| Tyrosine | about 35.0 to about 36.2 |
| Phenylalanine | about 59.3 to about 61.6 |
| Lysine | about 34.9 to about 38.0 |
| Histidine | about 31.3 to about 33.3 |
| Cysteine | about 22.6 to about 23.4 |
| Methionine | about 29.6 to about 33.1 |
| Tryptophan | about 11.0 to about 11.8 |

In a further embodiment, the present disclosure provides for a sunflower protein product having a protein content of at least about 65, at least about 70, at least about 75, at least about 80, at least about 85, at least about 90, or at least about 95 wt % (N×6.25) d.b., which has a chlorogenic acid content of about 56 to about 226 ppm.

In a further embodiment, the present disclosure provides for a sunflower protein product having a viscosity for a 10% protein solution tested at a shear rate of 1.28 (1/s) of less than about 30 mPa-s.

In a further embodiment of the product or products outlined above, the product has a viscosity for a 10% protein solution tested at a shear rate of 1.28 (1/s) of about 19.3 to about 28.8 mPa-s.

In a further embodiment, the present disclosure provides for a sunflower protein product having a phytic acid content greater than about 6 wt % d.b.

In a further embodiment of the product or products outlined above, the product has a phytic acid content of between 6.16 and 7.03 wt % d.b.

In a further embodiment, the present disclosure provides for a sunflower protein product having a sodium content of between about 0.2 and about 0.3 wt %.

In a further embodiment of the product or products outlined above, the product has a sodium content as above and a protein content of between 47.13 and 53.24 wt % (N×6.25) d.b.

In a further embodiment, the present disclosure provides for a sunflower protein product having an attribute from one or more of the following tables:
a protein content as defined in or captured by Table 2;
a solubility as defined in or captured by Table 3,
a dry colour as defined in or captured by Table 4;
a water binding capacity as defined in or captured by Table 5;
an oil binding capacity as defined in or captured by Table 6;
a phytic acid content as defined in or captured by Table 7;
an amino acid profile comprising one or more amino acids as defined or captured by Table 8 or Table 9;
a chlorogenic acid content as defined or captured by Table 10;
a sodium content as defined or captured by Table 11;
an acid hydrolysis fat content as defined or captured by Table 12; and/or a viscosity as defined or captured by Table 13;
In a further embodiment of the sunflower protein product or products outlined above, the product or products are derived from confectionery (also known as non-oilseed), black oil (also known as oilseed) or conoil type sunflower seed.

In a further embodiment of the sunflower protein product or products outlined above, the product or products are derived from dehulled sunflower seed, also known as sunflower kernels.

In a further embodiment of the sunflower protein product or products outlined above, the product or products are derived from a partially or fully defatted sunflower protein source.

In a further embodiment, the present disclosure provides for a pet food, animal feed, industrial product, cosmetic product or personal care product comprising a sunflower protein product such as that produced by the process or processes outlined above and/or herein, or a sunflower protein product outlined above and/or herein.

In a further embodiment, the present disclosure provides for a food or beverage comprising a sunflower protein product such as that produced by the process or processes outlined above and/or herein or a sunflower protein product as outlined above and/or herein.

In a further embodiment of the food or beverage or beverages outlined above, the food or beverage is:
a dairy alternative,
a meat alternative,
a seafood alternative,
a grain product,
a snack or sweet,
a fats and oils product,
a condiment or sauce, or
a nutritional product.

In a further embodiment of the food or beverage or beverages outlined above, the dairy alternative is:
a milk alternative beverage,
a frozen dessert,
a cheese alternative, or
a yogurt alternative.

In a further embodiment of the food or beverage or beverages outlined above, the meat alternative is:
a beef alternative,
a pork alternative, or
a poultry alternative.

In a further embodiment of the food or beverage or beverages outlined above, the seafood alternative is:
a tuna alternative,
a salmon alternative, or
a shrimp alternative.

In a further embodiment of the food or beverage or beverages outlined above, the grain product is:
a pasta,
a bread, or
a breakfast cereal.

In a further embodiment of the food or beverage or beverages outlined above, the snack or sweet is:
a cookie,
a cracker,
a bar product, or
a cake.

In a further embodiment of the food or beverage or beverages outlined above, the fats and oils product is:
a margarine, or
a dressing.

In a further embodiment of the food or beverage or beverages outlined above, the condiment or sauce is:
a tomato based sauce,
a non tomato based sauce,
a dip; or
a gravy.

In a further embodiment of the food or beverage or beverages outlined above, the nutritional product is:
a nutritional drink; or
a nutritional powder.

In a further embodiment of the food or beverage or beverages outlined above, the food or beverage is:
a sports drink;
an energy drink; or
a smoothie.

Other aspects and features of the disclosure will become apparent to those ordinarily skilled in the art upon review of the following description of specific embodiments of the disclosure.

### DETAILED DESCRIPTION

One or more illustrative embodiments have been described by way of example. It will be appreciated that embodiments and examples are provided for illustrative purposes intended for those skilled in the art, and are not meant to be limiting in any way. All references to embodiments, examples, aspects, compositions, solutions, and the like is intended to be illustrative and non-limiting.

The initial step of the process of providing the sunflower protein products as disclosed herein involves solubilizing sunflower protein from a sunflower protein source. The sunflower protein source may be any variety of sunflower seed used for human food or animal feeding purposes. Confectionery (also known as non-oilseed), black oil (also known as oilseed) and conoil types of sunflower seed may be used. The sunflower protein source may be used in the full fat form, partially defatted form (e.g. cold pressed cake/meal) or fully defatted form (e.g. pressed and solvent extracted meal). For the purpose of this disclosure, the terms “cake” and “meal” are used interchangeably. “Cake” is generally yielded from pressing and the solvent extraction of the cake yields a “meal”. Meal may also be considered a ground presscake. Pressed sunflower, encompassed by the terms “cake” and “meal” may be added to extraction solution without a grinding step when it is generally soft enough that it fragments when mixed with water or other appropriate solvent or liquid. The sunflower protein source may contain hulls (i.e. derived from seeds with hulls) or may be dehulled material (i.e. derived from seeds with the hulls removed, also known as kernels). Preferably the sunflower protein source is dehulled and defatted prior to use in the processes described herein. Where the sunflower protein source contains an appreciable amount of fat, an oil removal step may be required during the process. The particle size of the sunflower protein source may vary but it is preferred that the sunflower protein source is in the form of granules or a powder to facilitate more rapid wetting and more thorough mixing with the extraction solution. As mentioned above, some sunflower protein sources, such as certain cakes/meals from cold pressing may fragment when mixed with extraction solution. The sunflower protein source may also be ground before the extraction step to achieve a desired particle size. Ground sunflower protein source may be referred to as a flour. The sunflower protein recovered from the sunflower protein source may be the protein naturally occurring in the sunflower seed or the proteinaceous material may be a protein modified by genetic manipulation but possessing characteristic hydrophobic and polar properties of the natural protein.

The sunflower protein products of the present disclosure may be prepared from sunflower protein source by either a batch process or a continuous process or a semi-continuous process. Protein solubilization from the sunflower protein source material may be effected using water. The water used may be tap water or water having different levels of purity. Reverse osmosis (RO) purified water is preferred.

The pH of the extraction may be the natural pH of the combination of the water and the sunflower protein source, or the pH of the extraction may be adjusted up to any value between the natural pH and about 8.5, preferably the pH is adjusted within the range of about 6.8 to about 8.0, more preferably the pH is adjusted to about 6.8 to about 7.5. Suitable pH values for the extraction encompass the natural pH and include about 8.6 to about 8.5 or any value therebetween (optionally rounded to the nearest 0.1), or any subrange spanning between any two of these values, such as 6.8 to 8.0. For example, pH values of 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, and others are considered. Food grade sodium hydroxide, potassium hydroxide or any other conventional food grade alkali and combinations thereof may be added to the water to adjust the pH of the extraction as required. The food grade alkali is preferably added in aqueous solution form.

The solubilization of the protein may be effected at a temperature of from about 1° C. to about 100° C., preferably about 15° C. to about 65° C., more preferably about 50° C. to about 60° C., preferably accompanied by agitation to decrease the solubilization time, which is usually about 1 to about 60 minutes, preferably about 10 to about 30 minutes. It is preferred to effect the solubilization to extract substantially as much protein from the sunflower protein source as is practicable, so as to provide an overall high product yield. The pH values of the extraction and subsequent steps typically refer to values measured at room temperature (21-24° C.). For absence of doubt, when, for example, the extraction is conducted at an elevated temperature, the pH of the extraction mixture is such that a sample of extraction mixture cooled to room temperature has a pH reading in the specified range.

Extraction of the protein from the sunflower protein source, when conducted in a continuous operation, may be carried out in any manner consistent with effecting a continuous extraction of protein from the sunflower protein source. In one embodiment, the sunflower protein source is continuously mixed with the water and the mixture is conveyed through a pipe or conduit having a length and at a flow rate for a residence time sufficient to effect the desired extraction in accordance with the parameters described herein.

The concentration of sunflower protein source in the water during the solubilization step may vary widely. Typical concentration values are about 5 to about 20% w/v, preferably about 5 to about 15% w/v.

It will be appreciated that reference to solubilizing encompasses both complete and partial solubilization of the protein from the sunflower protein source.

The protein extraction step has the additional effect of solubilizing fats which may be present in the sunflower protein source, which then results in the fats being present in the aqueous phase.

The protein solution resulting from the extraction step generally has a protein concentration of about 0.5 to about 5 wt %, preferably about 1 to about 5 wt %.

The water of extraction may contain an antioxidant. The antioxidant may be any conventional antioxidant, such as ascorbic acid or sodium sulfite. Preferably the antioxidant is ascorbic acid. The quantity of antioxidant employed may vary from about 0.01 to about 1 wt % of the solution, preferably about 0.05 to about 0.15 wt %, more preferably about 0.05 to about 0.10 wt %. The antioxidant serves to inhibit oxidation of phenolics present in the protein solution and preferably inhibits the development of green colouration that may occur in sunflower protein solutions at alkaline pH.

The aqueous phase resulting from the extraction step then may be separated from the residual sunflower protein source, in any conventional manner, such as by centrifugation and/or filtration. Preferably the aqueous phase resulting from the extraction step is separated from the bulk of the residual sunflower protein source (coarse residual solids) using a decanter centrifuge and the resulting centrate further clarified using a disc stack centrifuge to remove finer residual solids. The coarse and finer residual solids may be further processed separately to provide separate products disclosed herein and as described in greater detail starting in paragraph [00153] (finer residual solids) and paragraph [00158](coarse residual solids). Preferably the coarse and finer solids are combined before or after further processing to provide a combined solids product. The coarse or combined residual solids may also be further processed to recover residual protein. When the coarse or combined residual solids are further processed to recover residual protein, the residual protein may be recovered by re-extracting the separated coarse or combined residual sunflower protein source with fresh water and the protein solution yielded upon separation as described above combined with the initial protein solution for further processing as described below. A counter-current extraction procedure may also be utilized. The separated coarse or combined residual sunflower protein source may alternatively be processed by any other conventional procedure to recover residual protein. Coarse and finer residual solids captured in the re-extraction or counter current extraction procedures may be further processed separately to provide separate products disclosed herein and, for example, as described in greater detail starting in paragraph [00153] (finer residual solids) and paragraph [00158](coarse residual solids). Preferably the coarse and finer solids are combined before or after further processing to provide a combined solids product. Utilizing the re-extraction or counter current extraction procedures may result in a lower quantity of chlorogenic acid in the residual solids compared to a single extraction. Lower chlorogenic acid content in the residual solids may result in better colour/quality for the products derived from the residual solids. The separation step may be conducted at the same temperature as the extraction step or at any temperature within the range of about 1° C. to about 100° C., preferably about 15° C. to about 65° C., more preferably about 50° C. to about 60° C. When the separation is done in more than one step (e.g. employing decanter centrifuge then disc stack centrifuge), different temperatures within the abovementioned range may employed for each step of the separation process.

It will be appreciated that reference herein to a separation step and to separation of the aqueous phase and residual sunflower protein source is intended to refer to both complete separation as well as to at least partial separation. It is to be understood that trace or minor amounts of residual components may be found in the aqueous phase, for example but not limited to: coarse residual protein source, finer residual solids, and/or fat/oil.

The aqueous sunflower protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer in the quantity described may be added in the extraction steps.

The separated aqueous sunflower protein solution may be subject to a defatting operation, if desired or required. Defatting of the separated aqueous sunflower protein solution may be achieved by any conventional procedure such as centrifugation and/or filtration. A three-phase centrifuge such as a three-phase separator may be used for the simultaneous separation of fat and residual solids from the protein solution with the three-phase centrifuge potentially being used instead of or in addition to the separation steps already described above. When a three-phase centrifuge is used in addition to the decanter and disc stack centrifuge described above, the order in which the disc stack and three-phase centrifuge steps are applied to the post-decanter protein solution may be varied. Solids collected by the three-phase centrifuge may be disposed of or further processed, alone or in combination with solids collected from the decanter centrifuge and/or disc stack centrifuge. Solids collected from the three-phase centrifuge may also be combined with the protein solution for further processing.

The aqueous sunflower protein solution may be treated with an adsorbent, such as granulated activated carbon, to remove colour and/or odour compounds. Such adsorbent treatment may be carried out under any conventional conditions, generally at the ambient temperature of the separated aqueous protein solution.

The aqueous sunflower protein solution is adjusted in pH to an acidic value in the range of about pH 1.5 to about pH 5.0 preferably about pH 2.0 to about pH 3.0. The pH of the aqueous sunflower protein may be adjusted by the addition of any food grade acid such as food grade hydrochloric acid solution or food grade phosphoric acid solution. Food grade organic acids such as citric acid may also be used. Suitable pH values for the acidified protein solution include a range of about 1.5 to about 5.0 or any value therebetween (optionally rounded to the nearest 0.1), or any subrange spanning between any two of these values, such as 2.0 to 3.0. For example, pH values of 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, and others are considered. The low pH of the acidified aqueous sunflower protein solution is believed to improve the flux rate of subsequent membrane processing. The low pH is also believed to have a positive impact on the colour and flavour of the sunflower protein product provided by the process.

The acidified aqueous sunflower protein solution is subsequently processed without a separation step to fractionate soluble and insoluble protein species. Eliminating the separation step and processing the material as one stream rather than two is advantageous at least in that the process is simpler and more economical.

The acidified aqueous sunflower protein solution may be subjected to a heat treatment to potentially aid to inactivate heat labile anti-nutritional factors, which may include trypsin inhibitors, present in such solution as a result of extraction from the sunflower protein source material during the extraction step. Such a heating step may also provide the additional benefit of reducing the microbial load. Generally, the protein solution is heated to a temperature of about 70° C. to about 160° C. for about 10 seconds to about 60 minutes, preferably about 80° C. to about 120° C. for about 10 seconds to about 5 minutes, more preferably about 85° C. to about 95° C. for about 30 seconds to about 5 minutes. The heat treated acidified sunflower protein solution then may be cooled for further processing as described below, to a temperature of about 2° C. to about 65° C., preferably about 50° C. to about 60° C.

If of adequate purity, the acidified aqueous sunflower protein solution may be directly dried to produce a sunflower protein product having a protein content of greater than 60 wt % (N×6.25) d.b. To provide a sunflower protein product having a decreased impurities content, such as a sunflower protein isolate, the acidified aqueous sunflower protein solution may be processed as described below prior to drying. Further processing as described below is also believed to have a beneficial effect on the flavour of the product.

The acidified aqueous sunflower protein solution may be concentrated to provide a concentrated sunflower protein solution having a protein concentration of about 5 to about 30 wt %, preferably about 5 to about 20 wt %, more preferably about 10 to about 20 wt %. It will be appreciated that concentrations of less than about 5 wt % may be considered as partially concentrated. Suitable protein concentrations include a range of about 5 to about 30 wt % or any value therebetween (optionally rounded to the nearest 0.1), or any subrange spanning between any two of these values, such as about 10 to about 20 wt %. For example, values of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 wt % and others are considered.

The concentration step may be effected in any conventional manner consistent with batch or continuous operation, such as by employing any conventional selective membrane technique, such as ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, more preferably about 10,000 to about 100,000 daltons having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated acidified sunflower protein solution then may be subjected to a diafiltration step using water as the diafiltration solution. The water may be used as the diafiltration solution without any pH adjustment or the water may be adjusted with any food grade acid to a pH down to that of the concentrated acidified sunflower protein solution. The diafiltration may be done in stages using water at different pH values, such as initial volumes of diafiltration using water adjusted to the pH of the protein solution followed by additional volumes of diafiltration using water without pH adjusting agent. In general, diafiltration may be effected using from about 0.5 to about 40 volumes of diafiltration solution, preferably about 2 to about 25 volumes of diafiltration solution, more preferably about 2 to about 5 volumes of diafiltration solution. Suitable numbers of diafiltration volumes include a range of about 0.5 to about 40 or any value therebetween (optionally rounded to the nearest 0.1), or any subrange spanning between any two of these values, such as about 2 to about 25. For example, values of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 and others are considered. In the diafiltration operation, further quantities of contaminants are removed from the aqueous acidified sunflower protein solution by passage through the membrane with the permeate. This purifies the aqueous protein solution and may also reduce its viscosity. The diafiltration operation may be effected until no significant further quantities of contaminants or visible colour are present in the permeate or until the retentate has been sufficiently purified so as to provide a sunflower protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons, having regard to different membrane materials and configuration.

Alternatively, the diafiltration step may be applied to the acidified aqueous protein solution prior to concentration or to partially concentrated acidified aqueous protein solution. Diafiltration may also be applied at multiple points during the concentration process. When diafiltration is applied prior to concentration or to the partially concentrated solution, the resulting diafiltered solution may then be additionally concentrated. Diafiltering multiple times as the protein solution is concentrated may allow a higher final, fully concentrated protein concentration to be achieved. This reduces the volume of material to be dried.

The concentration step and the diafiltration step may be effected herein in such a manner that the sunflower protein product subsequently recovered contains less than about 90 wt % protein (N×6.25) d.b., such as at least about 60 wt % protein (N×6.25) d.b. By partially concentrating and/or partially diafiltering the acidified aqueous sunflower protein solution, it is possible to only partially remove contaminants. This protein solution may then be dried to provide a sunflower protein product with lower levels of purity.

An antioxidant may be present in the diafiltration water during at least part of the diafiltration step. The antioxidant may be any conventional antioxidant, such as ascorbic acid or sodium sulfite. Preferably the antioxidant is ascorbic acid. The quantity of antioxidant employed in the diafiltration water depends on the materials employed and may vary from about 0.01 to about 1 wt %, preferably about 0.05 to about 0.15 wt %, more preferably about 0.05 to about 0.10 wt %. The antioxidant serves to inhibit oxidation of phenolics present in the protein solution.

The optional concentration step and the optional diafiltration step may be effected at any conventional temperature, generally about 2° C. to about 65° C., preferably about 50° C. to about 60° C., and for the period of time to effect the desired degree of concentration and diafiltration. The temperature and other conditions used to some degree depend upon the membrane equipment used to effect the membrane processing, the desired protein concentration of the solution and the efficiency of the removal of contaminants to the permeate.

As alluded to earlier, sunflowers can contain anti-nutritional trypsin inhibitors. The level of trypsin inhibitor activity in the final sunflower protein product can be controlled by the manipulation of various process variables.

As noted above, heat treatment of the acidified aqueous sunflower protein solution may be used to potentially aid to inactivate heat-labile trypsin inhibitors. The partially concentrated or fully concentrated acidified sunflower protein solution may also be heat treated to potentially inactivate heat labile trypsin inhibitors. When the heat treatment is applied to the partially concentrated acidified sunflower protein solution, the resulting heat treated solution may then be additionally concentrated.

The concentration and/or diafiltration steps may be operated in a manner favourable for removal of trypsin inhibitors in the permeate along with the other contaminants. Removal of the trypsin inhibitors is promoted by using a membrane of larger molecular weight cut-off, such as 30,000 to 1,000,000 Da, operating the membrane at elevated temperatures, such as about 30° C. to about 65° C., preferably about 50° C. to about 60° C. and employing greater volumes of diafiltration medium, such as 10 to 40 volumes.

Acidifying and membrane processing the sunflower protein solution at a lower pH, such as about 1.5 to about 2.5, may reduce the trypsin inhibitor activity relative to processing the solution at higher pH, such as about 2.5 to about 5.0. When the protein solution is concentrated and/or diafiltered at the low end of the pH range, it may be desired to raise the pH of the solution prior to drying. The pH of the concentrated and/or diafiltered protein solution may be raised to the desired value, for example pH 3, by the addition of any conventional food grade alkali, such as sodium hydroxide, potassium hydroxide and combinations thereof. The food grade alkali is preferably added in aqueous solution form.

Further, a reduction in trypsin inhibitor activity may be achieved by exposing sunflower materials to reducing agents that disrupt or rearrange the disulfide bonds of the inhibitors. Suitable reducing agents include, but are not limited to, sodium sulfite, cysteine and N-acetylcysteine.

The addition of such reducing agents may be effected at various stages of the overall process. The reducing agent may be added with the sunflower protein source material in the extraction step, may be added to the aqueous sunflower protein solution following removal of residual sunflower protein source material, may be added to the diafiltered retentate before drying or may be dry blended with the dried sunflower protein product. The addition of the reducing agent may be combined with the heat treatment and/or membrane processing steps, as described above.

If it is desired to retain active trypsin inhibitors in the protein solution, this can be achieved by not utilizing reducing agents, utilizing a concentration and diafiltration membrane with a smaller molecular weight cut-off, operating the membrane at lower temperatures and employing fewer volumes of diafiltration medium.

The optionally concentrated and optionally diafiltered protein solution may be subject to a further defatting operation, if required. Defatting of the optionally concentrated and optionally diafiltered acidified protein solution may be achieved by any conventional procedure.

The optionally concentrated and optionally diafiltered acidified protein solution may be treated with an adsorbent, such as granulated activated carbon, to remove colour and/or odour compounds. Such adsorbent treatment may be carried out under any conventional conditions, generally at the ambient temperature of the protein solution.

The optionally concentrated and optionally diafiltered acidified protein solution may be pasteurized prior to drying or further processing. Such pasteurization may be effected under any conventional pasteurization conditions. Generally, the optionally concentrated and optionally diafiltered acidified sunflower protein solution is heated to a temperature of about 550 to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized sunflower protein solution then may be cooled, such as to a temperature of about 200 to about 35° C.

The optionally concentrated, optionally diafiltered and optionally pasteurized sunflower protein solution then may be dried by any conventional means such as spray drying or freeze drying to provide a sunflower protein product. Alternatively, the optionally concentrated, optionally diafiltered and optionally pasteurized sunflower protein solution may be raised in pH to a value of less than about 8.0, preferably about 6.0 to about 8.0, more preferably about 6.5 to about 7.5, to form a pH adjusted sunflower protein solution, prior to optional drying. Suitable pH values for the pH adjusted protein solution include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The pH may be raised in any conventional manner such as by the addition of sodium hydroxide, potassium hydroxide or any other conventional food grade alkali and combinations thereof. The food grade alkali is preferably added in aqueous solution form. If the protein solution is not pasteurized before pH adjustment, the pasteurization may be conducted after the pH adjustment using the conditions described above.

As a further alternative, the pH adjusted sunflower protein solution may be subjected to membrane processing such as a concentration step and/or a diafiltration step using water prior to optional pasteurization and optional drying as described above. This membrane processing removes additional impurities including salts formed in the pH adjustment step. When diafiltration is employed, the diafiltration water is preferably at a pH equal to that of the protein solution being diafiltered. Such diafiltration may be effected using from about 0.5 to about 40 volumes of diafiltration solution, preferably about 2 to about 25 volumes, more preferably about 2 to about 5 volumes of diafiltration solution. Suitable numbers of diafiltration volumes include a range of about 0.5 to about 40 or any value therebetween (optionally rounded to the nearest 0.1), or any subrange spanning between any two of these values, such as about 2 to about 25. For example, values of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 and others are considered. The diafiltration operation may be effected until no significant further quantities of contaminants or visible colour are present in the permeate or until the retentate has been sufficiently purined so as, when dried, to provide a sunflower protein isolate with a protein content of at least about 90 wt % (N×6.25) d.b. The membrane processing of the pH adjusted material may be effected using the same membrane as for the concentration or diafiltration of the acidified protein solution. However, if desired, the membrane processing of the pH adjusted material may be effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons, having regard to different membrane materials and configurations.

As a further alternative, the optionally concentrated and optionally diafiltered acidified sunflower protein solution, the pH adjusted sunflower protein solution or the membrane processed pH adjusted sunflower protein solution may be jet cooked prior to drying in order to modify the functional properties of the protein product. In such jet cooking, the protein solution may be heated to a temperature of about 110° C. to about 150° C. for a time of about 10 seconds to about 1 minute. Preferably the product is heated to about 140° C. to 145° C. for about 40 to 50 seconds.

The sunflower protein product (prepared with or without the pH adjustment step prior to optional drying) has a protein content greater than about 60 wt % (N×6.25) d.b. Preferably the sunflower protein product has a protein content greater than about 65, 70, 75, 80, 85 and 90 wt % (N×6.25) d.b. Most preferably, the sunflower protein product is an isolate with a protein content in excess of about 95 wt % protein (N×6.25) d.b. Suitable protein content values include a range of about 60-100 wt % or higher, or any value therebetween (optionally rounded to the nearest 0.1), or any subrange spanning between any two of these values, such as 65-95 wt %. For example, values of 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 wt % and others are considered. Note, it will be appreciated that values higher than 100% are possible due, for example, to the calculation to convert nitrogen determined to percent protein (N×6.25) (see for example the results in Table 2).

The sunflower protein product prepared from the acidified aqueous sunflower protein solution has organoleptic and functional properties making it suitable for use in various food and beverage products including dairy alternative products including but not limited to dairy alternatives (for example milk alternative beverages, frozen desserts, plant based cheese, yogurt alternative products and the like), meat alternatives (for example beef alternatives, pork alternatives, poultry alternatives and the like), seafood alternatives (for example tuna alternatives, salmon alternatives, shrimp alternatives and the like), grain products (for example pastas, breads, breakfast cereals and the like), snacks and sweets (for example cookies, crackers, bars, cakes, candies, chocolates and the like), beverages (for example sports drinks, energy drinks, smoothies and the like), fats and oils products (for example margarines, dressings and the like), condiments and sauces (for example tomato based or non-tomato based sauces, dips, gravies and the like) and nutritional products (for example drinks, powders and the like). The sunflower protein product prepared from the acidified aqueous sunflower protein solution is rich in sulfur containing amino acids. The sunflower protein product may be formulated into a functional food or beverage. The sunflower protein product may be formulated into a food or beverage product to provide protein fortification. The sunflower protein product may be formulated into a food or beverage product to replace other protein ingredients (including as an extender in meat or dairy products) or to replace non-protein functional ingredients. Other uses of the sunflower protein product are in pet foods, animal feed and in industrial, cosmetic and personal care products.

In accordance with another aspect of the present disclosure, the finer residual solids captured by the disc stack centrifuge in the separation step may be further processed to provide a sunflower protein product. The finer solids may be optionally diluted with water then optionally dried to form a sunflower protein product having a protein content of at least about 45 wt % (N×6.25) d.b., preferably at least about 50 wt % (N×6.25) d.b., more preferably at least about 55 wt % (N×6.25) d.b, and more preferably at least about 60 wt % (N×6.25) d.b. Alternatively, the pH of the optionally diluted finer residual solids may be adjusted to a value between about pH 6.0 and about 8.0, by any conventional means such as by the addition of sodium hydroxide, potassium hydroxide or any other conventional food grade alkali and combinations thereof or the addition of hydrochloric acid, phosphoric acid, citric acid or any other conventional food grade acid and combinations thereof as needed prior to optional drying to form a sunflower protein product having a protein content of at least about 45 wt % (N×6.25) d.b., preferably at least about 50 wt % (N×6.25) d.b., more preferably at least about 55 wt % (N×6.25) d.b. and more preferably at least about 60 wt % (N×6.25) d.b. Suitable pH values for the pH adjusted finer residual solids include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The food grade alkali or acid is preferably added in aqueous solution form.

Preferably, the finer residual solids are washed in order to remove contaminants and improve the purity and flavour of the product. The finer solids may be washed by suspending the solids in between about 1 and about 20 volumes, preferably about 1 to about 10 volumes of water, preferably RO water. The washing step may be conducted at any conventional temperature such as about 15° C. to about 65° C., preferably about 50° C. to about 60° C. The finer residual solids may be mixed with the wash solution for any conventional length of time, preferably 15 minutes or less. The washed finer residual solids may then be separated from the used wash solution by any conventional means such as by centrifugation using a disc stack centrifuge. The used wash solution may optionally be defatted then added to the protein solution arising from the initial separation step for further processing as described above. Alternatively, the used wash solution may optionally be defatted then added to the optionally concentrated and optionally diafiltered acidified protein solution prior to pH adjustment and further processing as described above. The washed finer residual solids may be optionally diluted with water then optionally dried by any conventional means such as spray drying or freeze drying to provide a sunflower protein product having a protein content of at least about 45 wt % (N×6.25) d.b., preferably about 50, 55, 60 and 65 wt % (N×6.25) d.b., more preferably about 70 wt % (N×6.25) d.b. Alternatively, the pH of the optionally diluted washed finer solids may be adjusted to a value between about 6.0 to about 8.0, by any conventional means such as by the addition of sodium hydroxide, potassium hydroxide or any other conventional food grade alkali and combinations thereof or the addition of hydrochloric acid, phosphoric acid, citric acid or any other conventional food grade acid and combinations thereof as needed, prior to optional drying. As a further alternative, the finer residual solids may be pH adjusted during the washing step by adjusting the mixture of finer residual solids and wash water to a pH between about 6.0 to about 8.0 using food grade alkali or acid as needed, then collecting the solids by centrifugation and optionally drying the solids. Suitable pH values for the pH adjusted washed finer residual solids include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The food grade alkali or acid is preferably added in aqueous solution form.

A pasteurization step may be employed on the optionally diluted and optionally pH adjusted finer residual solids or optionally diluted and optionally pH adjusted washed finer residual solids prior to the optional drying step. Such pasteurization may be effected under any conventional pasteurization conditions. Generally, the optionally diluted and optionally pH adjusted finer residual solids or optionally diluted and optionally pH adjusted washed finer residual solids are heated to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized optionally diluted and optionally pH adjusted finer residual solids or optionally diluted and optionally pH adjusted washed finer residual solids then may be cooled, such as to a temperature of about 200 to about 35° C.

The optionally diluted and optionally pH adjusted finer residual solids or optionally diluted and optionally pH adjusted washed finer residual solids may be jet cooked prior to drying in order to modify the functional properties of the protein product. In such jet cooking, the protein solution may be heated to a temperature of about 110° C. to about 150° C. for a time of about 10 seconds to about 1 minute. Preferably the product is heated to about 135° C. to about 145° C. for about 40 to 50 seconds.

The product derived from the finer residual solids may be used in food and beverage applications as described above for the sunflower protein product prepared from the aqueous sunflower protein solution. Other uses of the sunflower protein product derived from the finer residual solids are in pet foods, animal feed and in industrial, cosmetic and personal care products.

In accordance with another aspect of the present disclosure, the coarse residual solids captured by the decanter centrifuge in the initial separation step may be further processed to provide a sunflower protein product. The coarse residual solids may be optionally diluted with water, preferably RO water, then optionally dried to form a sunflower protein product having a protein content of at least about 25 wt % (N×6.25) d.b., preferably at least about 30, 35, 40, 45, 50 or 55 wt % (N×6.25) d.b., more preferably at least about 60 wt % (N×6.25) d.b. Alternatively, the pH of the optionally diluted coarse residual solids may be adjusted to a value between about 6.0 to about 8.0, by any conventional means such as by the addition of sodium hydroxide, potassium hydroxide or any other conventional food grade alkali and combinations thereof or the addition of hydrochloric acid, phosphoric acid, citric acid or any other conventional food grade acid and combinations thereof as needed prior to optional drying to form a sunflower protein product having a protein content of at least about 25 wt % (N×6.25) d.b., preferably at least about 30, 35, 40, 45, 50 or 55 wt % (N×6.25) d.b., more preferably at least about 60 wt % (N×6.25) d.b. Suitable pH values for the pH adjusted coarse residual solids include a range of about 6.0 to about 8.0 or any value therebetween (optionally rounded to the nearest 0.1), or any subrange spanning between any two of these values, such as about 6.5 to about 7.5. For example, values of 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 and others are considered. The food grade alkali or acid is preferably added in aqueous solution form.

A pasteurization step may be employed on the optionally diluted and optionally pH adjusted coarse residual solids prior to the optional drying step. Such pasteurization may be effected under any conventional pasteurization conditions. Generally, the optionally diluted and optionally pH adjusted coarse residual solids are heated to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds. The pasteurized optionally diluted and optionally pH adjusted coarse residual solids then may be cooled, such as to a temperature of about 20° C. to about 35° C.

The product derived from the coarse residual solids may be used in food and beverage applications as described above for the sunflower protein product prepared from the aqueous sunflower protein solution. Other uses of the sunflower protein product derived from the coarse residual solids are in pet foods, animal feed and in industrial, cosmetic and personal care products. When the coarse residual solids are used as a food ingredient, the sunflower protein source material is typically dehulled material.

In accordance with another aspect of the present disclosure, the coarse residual solids captured by the decanter centrifuge and the finer residual solids captured by the disc stack centrifuge in the initial separation step are optionally processed as described above then combined to form a sunflower protein product having a protein content of at least about 40 wt % (N×6.25) d.b., preferably at least about 45, 50 or 55 wt % (N×6.25) d.b., more preferably at least about 60 wt % (N×6.25) d.b. If not already pH adjusted, pasteurized or dried before combination, these steps may be applied to the combined solids as described for the processing of the individual solids fractions.

The combined residual solids product may be used in food and beverage applications as described above for the sunflower protein product prepared from the aqueous sunflower protein solution. Other uses of the combined residual solids product are in pet foods, animal feed and in industrial, cosmetic and personal care products. When the combined residual solids are used as a food ingredient, the sunflower protein source material is typically dehulled material.

### EXAMPLES

### Example 1

[00164]30 kg of cold pressed black oil sunflower seed meal was combined with 300 L of reverse osmosis purified (RO) water having a temperature of 61.3° C., 0.30 kg of ascorbic acid and 0.76 kg of 25% NaOH solution. The mixture was stirred for 10 minutes. A portion of the suspended (coarse) solids (94.38 kg) were removed by centrifugation using a decanter centrifuge to provide a protein solution having a protein content of 1.34 wt % and a pH of 6.96. The protein solution was then further clarified by centrifugation using a disc stack centrifuge to remove additional suspended (finer) solids (7.6 kg) and provide a protein solution having a protein content of 1.14 wt %. This protein solution was then fed to a three-phase separator which removed 19.94 kg of oil phase and another 8.58 kg of suspended solids and provided 165 L of defatted protein solution having a protein content of 1.06 wt %. The pH of this solution was adjusted from 6.79 to 1.93. Typically, HCl solution (concentrated HCl diluted with one volume of RO water) is used for the pH adjustment.

The acidified protein solution was then reduced in volume from 165 L to 40 L by concentration on a polyethersulfone membrane having a molecular weight cut-off of 10,000 daltons, operated at a temperature of about 49° C. The protein solution, with a protein content of 3.83 wt %, was then diafiltered on the same membrane with 160 L of RO water to which acid (typically HCl solution is used) was added to about pH 2, with this diafiltration operation conducted at about 44° C. The protein solution was then additionally diafiltered with 40 L of RO water at a temperature of about 45° C. The diafiltered protein solution, having a protein content of 3.94 wt % was then further concentrated to a protein content of 5.79 wt %. This diafiltered and concentrated protein solution had a pH of 2.57. 26.23 kg of diafiltered and concentrated protein solution was pasteurized at 72° C. for 16 seconds. 5.92 kg of pasteurized solution was spray dried to yield a product having a protein content of 83.56% (N×6.25) d.b. The product was termed SF08-B10-22A SF871A. 19.09 kg of pasteurized solution was adjusted to pH 7.26 with 0.22 kg of 25% NaOH then spray dried to yield a product having a protein content of 81.26% (N×6.25) d.b. The product was termed SF08-B10-22A SF871N.

The coarse solids collected by the decanter centrifuge had a protein content of 4.75 wt % and a solids content of 17.31 wt % (27.44% protein (N×6.25) d.b.).

The finer solids collected by the disc stack centrifuge had a protein content of 5.25 wt % and a solids content of 11.33%. The dry basis protein content of this material was therefore 46.34% (N×6.25).

Note all cited pH values were from measurements conducted with the sample at room temperature unless otherwise noted. The extraction slurry was noted as having a pH of 7.05 at 61° C.

### Example 2

30 kg of sunflower flour/meal (partially defatted, made from kernels) was combined with 300 L of reverse osmosis purified (RO) water having a temperature of 63.5° C., 0.30 kg of ascorbic acid and 0.76 kg of 25% NaOH solution. The mixture was stirred for 15 minutes. A portion of the suspended (coarse) solids (94.08 kg) were removed by centrifugation using a decanter centrifuge to provide a protein solution having a protein content of 3.39 wt % and a pH of 7.39. The protein solution was then further clarified by centrifugation using a disc stack centrifuge to remove additional suspended (finer) solids (15.24 kg) and provide a protein solution having a protein content of 2.48 wt %. This protein solution was then fed to a three-phase separator which removed 20.14 kg of oil phase and another 8.24 kg of suspended solids and provided 208 L of defatted protein solution having a protein content of 2.35 wt %. The pH of this solution was adjusted from 7.19 to 2.06 by the addition of 2.28 kg of HCl solution (concentrated HCl diluted with one volume of RO water).

The acidified protein solution was then reduced in volume from 208 L to 60 L by concentration on a polyethersulfone membrane having a molecular weight cut-off of 10,000 daltons, operated at a temperature of about 48° C. The protein solution, with a protein content of 8.39 wt %, was then diafiltered on the same membrane with 180 L of RO water to which acid (typically HCl solution is used) was added to about pH 2, with this diafiltration operation conducted at about 49° C. A sample of the diafiltered protein solution was freeze dried to provide a product with an as-is protein content of 93.96 wt % (N×6.25). This product was termed SF11-B14-22A SF871A. The remaining diafiltered protein solution was diluted with 30 L of RO water and the pH adjusted to 7.20 by the addition of 1.10 kg of 25% NaOH. A sample of the pH adjusted protein solution was freeze dried to provide a product with an as-is protein content of 87.90 wt % (N×6.25). This product was termed SF11-B14-22A SF871N. The pH adjusted protein solution was concentrated until 30 L of permeate was collected and then diafiltered with another 90 L of RO water at about 52° C. and further concentrated to a protein content of 9.67 wt %. This diafiltered and concentrated protein solution had a pH of 7.36. 23.08 kg of diafiltered and concentrated protein solution was pasteurized at about 72° C. for at least 1 minute. 22.9 kg of pasteurized solution was spray dried to yield a product having a protein content of 98.44% (N×6.25) d.b. The product was termed SF11-B14-22A SF871NL.

The coarse solids collected by the decanter centrifuge had a protein content of 6.84 wt % and a solids content of 15.60 wt % (43.85% protein (N×6.25) d.b.).

The finer solids collected by the disc stack centrifuge had a protein content of 9.91 wt % and a solids content of 18.23%. The dry basis protein content of this material was therefore 54.36% (N×6.25).

Note all cited pH values were from measurements conducted with the sample at room temperature unless otherwise noted. The extraction slurry was noted as having a pH of 7.13 at 58.7° C.

### Example 3

30 kg of sunflower flour/meal (partially defatted, made from kernels) was combined with 300 L of reverse osmosis purified (RO) water having a temperature of 64.3° C., 0.30 kg of ascorbic acid and 0.80 kg of 25% NaOH solution. The mixture was stirred for 15 minutes. A portion of the suspended (coarse) solids (90.37 kg) were removed by centrifugation using a decanter centrifuge to provide a protein solution having a protein content of 3.24 wt % and a pH of 7.38. This protein solution was then fed to a three-phase separator which removed 28.56 kg of oil phase and 7.24 kg of suspended solids and provided 196 L of defatted protein solution having a protein content of 2.75 wt %.

The 196 L of defatted protein solution was combined with the 7.24 kg of solids collected by the three phase separator and the pH of the mixture was adjusted from 7.22 to 2.05 by the addition of 2.82 kg of HCl solution (concentrated HCl diluted with one volume of RO water). The acidified mixture was reduced in volume to 80 L by concentration on a polyethersulfone membrane having a molecular weight cut-off of 10,000 daltons, operated at a temperature of about 48° C. The protein solution, with a protein content of 7.60 wt %, was then diafiltered on the same membrane with 160 L of RO water to which acid (typically HCl solution is used) was added to about pH 2, with this diafiltration operation conducted at about 51° C. The protein solution was then additionally diafiltered with 80 L of RO water at a temperature of about 52° C. The diafiltered protein solution, having a protein content of 7.05 wt % was then adjusted in pH to about 7.17 by the addition of 1.12 kg 25% NaOH. The pH adjusted protein solution was diafiltered with 160 L of RO water at about 53° C. then further concentrated to a protein content of 9.63 wt %. 44.04 kg of diafiltered and concentrated protein solution was pasteurized at about 72° C. for about 1 minute. 40.84 kg of pasteurized solution was spray dried to yield a product having a protein content of 91.85% (N×6.25) d.b. The product was termed SF11-B16-22A SF871NL.

The coarse solids collected by the decanter centrifuge had a protein content of 6.11 wt % and a solids content of 13.94 wt % (43.83% protein (N×6.25) d.b.).

Note all cited pH values were from measurements conducted with the sample at room temperature unless otherwise noted. The extraction slurry was noted as having a pH of 7.15 at 61.5° C.

### Example 4

[00178]15 kg of commercial, solvent defatted sunflower seed meal was combined with 150 L of reverse osmosis purified (RO) water having a temperature of 63.1° C., 0.15 kg of ascorbic acid and 0.44 kg of 25% NaOH solution. The mixture was stirred for about 25 minutes. A portion of the suspended (coarse) solids (31.70 kg) were removed by centrifugation using a decanter centrifuge to provide a protein solution having a protein content of 1.20 wt % and a pH of 7.08. The pH of this solution was adjusted to 2.02 by the addition of 1.38 kg of HCl solution (concentrated HCl diluted with one volume of RO water).

130 L of acidified protein solution was reduced in volume to 45 L by concentration on a polyethersulfone membrane having a molecular weight cut-off of 10,000 daltons, operated at a temperature of about 48° C. The protein solution, with a protein content of 3.05 wt %, was then diafiltered on the same membrane with 180 L of RO water to which acid (typically HCl solution is used) was added to pH 1.97, with this diafiltration operation conducted at about 52° C. The protein solution was then additionally diafiltered with 45 L of RO water at a temperature of about 54° C. The diafiltered protein solution, having a protein content of 3.23 wt % was then further concentrated to a protein content of 6.67 wt %. The pH of this protein solution was adjusted to about 7.05 (typically 25% NaOH is used) then the solution was pasteurized at 72° C. for 16 seconds. 19.72 kg of pasteurized solution was spray dried to yield a product having a protein content of 85.64% (N×6.25) d.b. The product was termed SF13-C01-22A SF871N.

The coarse solids collected by the decanter centrifuge had a protein content of 9.24 wt % and a solids content of 29.46 wt % (31.36% protein (N×6.25) d.b.).

Note all cited pH values were from measurements conducted with the sample at room temperature unless otherwise noted. The extraction slurry was noted as having a pH of 7.12 at 59.3° C.

### Example 5

[00182]30 kg of sunflower flour/meal (partially defatted, made from kernels) was combined with 300 L of reverse osmosis purified (RO) water having a temperature of 63.1° C., 0.15 kg of ascorbic acid and 0.82 kg of 25% NaOH solution. The mixture was stirred for 15 minutes. A portion of the suspended (coarse) solids (96.75 kg) were removed by centrifugation using a decanter centrifuge to provide a protein solution having a protein content of 3.53 wt % and a pH of 7.58. The protein solution was then further clarified by centrifugation using a disc stack centrifuge to remove additional suspended (finer) solids (11.82 kg) and provide a protein solution having a protein content of 3.08 wt %. This protein solution was then fed to a three-phase separator which removed 33.54 kg of oil phase and another 9.58 kg of suspended solids and provided 205 L of defatted protein solution having a protein content of 2.84 wt %. The pH of this solution was adjusted from 7.48 to 1.97 by the addition of 2.18 kg of HCl solution (concentrated HCl diluted with one volume of RO water).

The acidified protein solution was then reduced in volume from 205 L to 75 L by concentration on a polyethersulfone membrane having a molecular weight cut-off of 10,000 daltons, operated at a temperature of about 49° C. The protein solution, with a protein content of 6.64 wt %, was then diafiltered on the same membrane with 225 L of RO water to which acid (typically HCl solution is used) was added to about pH 2, with this diafiltration operation conducted at about 54° C. The diafiltered protein solution was then adjusted to pH 7.65 by the addition of 1.0 kg of 25% NaOH. The pH adjusted protein solution was then diafiltered with 150 L of RO water at about 51° C. and further concentrated to a protein content of 7.60 wt %. This diafiltered and concentrated protein solution had a pH of 7.79. A 18.92 kg portion of diafiltered and concentrated protein solution was pasteurized at about 72° C. for 16 seconds. 20.44 kg of pasteurized solution was spray dried to yield a product having a protein content of 95.91% (N×6.25) d.b. The product was termed SF11-C02-22A SF871NL. Another 20 kg portion of diafiltered and concentrated protein solution was jet cooked at 140° C. for about 45 seconds. 22.08 kg of jet cooked material was spray dried to yield a product having a protein content of 95.61 (N×6.25) d.b.

The coarse solids collected by the decanter centrifuge had a protein content of 6.55 wt % and a solids content of 14.75 wt % (44.41% protein (N×6.25) d.b.).

The finer solids collected by the disc stack centrifuge had a protein content of 10.51 wt % and a solids content of 18.04%. The dry basis protein content of this material was therefore 58.26% (N×6.25).

Note all cited pH values were from measurements conducted with the sample at room temperature unless otherwise noted. The extraction slurry was noted as having a pH of 7.15 at 59.9° C.

### Example 6

[00187]30 kg of sunflower cake/meal (prepared by pressing black oil sunflower kernels) was combined with 300 L of reverse osmosis purified (RO) water having a temperature of 61.1° C., 0.30 kg of ascorbic acid and an unrecorded amount of 25% NaOH solution. The mixture was stirred for 10 minutes. A portion of the suspended (coarse) solids (83.2 kg) were removed by centrifugation using a decanter centrifuge to provide a protein solution having a protein content of 3.06 wt % and a pH of 7.49. This protein solution was then fed to a three-phase separator which removed 19.9 kg of oil phase and another 29.38 kg of suspended solids and provided 200 L of defatted protein solution having a protein content of 2.66 wt %. The pH of this solution was adjusted from 7.39 to 2.06 by the addition of 3.08 kg of HCl solution.

The acidified protein solution was then reduced in volume from 200 L to 60 L by concentration on a polyethersulfone membrane having a molecular weight cut-off of 10,000 daltons, operated at a temperature of about 47° C. The protein solution, with a protein content of 7.46 wt %, was then diafiltered on the same membrane with 180 L of RO water to which acid (typically HCl solution is used) was added to about pH 2, with this diafiltration operation conducted at about 37° C. The diafiltered protein solution was then adjusted to pH 7.15 by the addition of 0.9 kg of 25% NaOH. The pH adjusted protein solution was then diafiltered with 120 L of RO water at about 53° C. and further concentrated to a protein content of 10.27 wt %. This diafiltered and concentrated protein solution had a pH of 6.78. The membrane system was flushed with water and the flush water added to the diafiltered and concentrated protein solution to provide a solution with a protein content of 6.42 wt % and a pH of 6.84. 49.30 kg of this solution was pasteurized at 72° C. for 16 seconds. 49.14 kg of pasteurized solution was spray dried to yield a product having a protein content of 99.37% (N×6.25) d.b. The product was termed SF12-C08-22A SF871NL.

The coarse solids collected by the decanter centrifuge had a protein content of 6.37 wt % and a solids content of 15.93 wt % (39.99% protein (N×6.25) d.b.).

Note all cited pH values were from measurements conducted with the sample at room temperature unless otherwise noted.

### Example 7

30 kg of sunflower flour/meal (partially defatted, made from kernels) was combined with 300 L of reverse osmosis purified (RO) water having a temperature of 61.2° C., 0.30 kg of ascorbic acid and 0.82 kg of 25% NaOH solution. The mixing time was not recorded. Typically, mixing time is between 10 and 30 minutes. A portion of the suspended (coarse) solids (96.03 kg) were removed by centrifugation using a decanter centrifuge to provide a protein solution having a protein content of 3.39 wt % and a pH of 7.27. The protein solution was then fed to a three-phase separator which removed 35.48 kg of oil phase and 21.64 kg of suspended solids and provided 160 L of defatted protein solution having a protein content of 3.08 wt %. The pH of this solution was adjusted from 7.21 to 3.04 by the addition of 1.52 kg of HCl solution.

The acidified protein solution was then reduced in volume from 160 L to 60 L by concentration on a polyethersulfone membrane having a molecular weight cut-off of 10,000 daltons, operated at a temperature of about 47° C. The protein solution, with a protein content of 6.90 wt %, was then diafiltered on the same membrane with 180 L of RO water to which acid (typically HCl solution is used) was added to about pH 3, with this diafiltration operation conducted at about 54° C. The diafiltered protein solution was then adjusted to pH 7.21 by the addition of 0.64 kg of 25% NaOH. The pH adjusted protein solution was then diafiltered with 120 L of RO water at about 50° C. and further concentrated to a protein content of 10.39 wt %. This diafiltered and concentrated protein solution had a pH of 7.20. 33.41 kg of diafiltered and concentrated protein solution was pasteurized at 72° C. for 16 seconds. 32.86 kg of pasteurized solution was spray dried to yield a product having a protein content of 91.86% (N×6.25) d.b. The product was termed SF11-C09-22A SF871NL.

The coarse solids collected by the decanter centrifuge had a protein content of 6.92 wt % and a solids content of 15.12 wt % (45.77% protein (N×6.25) d.b.).

Note all cited pH values were from measurements conducted with the sample at room temperature unless otherwise noted. The extraction slurry was noted as having a pH of 7.17 at 45.7° C.

### Example 8

30 kg of sunflower cake/meal (prepared by pressing sunflower kernels) was combined with 300 L of reverse osmosis purified (RO) water having a temperature of 62.3° C., 0.30 kg of ascorbic acid and 0.50 kg of 25% NaOH solution. The mixture was stirred for 15 minutes. A portion of the suspended (coarse) solids (54.32 kg) were removed by centrifugation using a decanter centrifuge to provide a protein solution having a protein content of 1.70 wt % and a pH of 7.24. This protein solution was then fed to a three-phase separator which removed 30 kg of oil phase and another 9.5 kg of suspended solids and provided 235 L of defatted protein solution having a protein content of 1.38 wt %. The pH of this solution was adjusted from 7.04 to 2.92 by the addition of 1.38 kg of HCl solution (concentrated HCl diluted with one volume of RO water).

The acidified protein solution was then reduced in volume from 235 L to 50 L by concentration on a polyethersulfone membrane having a molecular weight cut-off of 10,000 daltons, operated at a temperature of about 52° C. The protein solution, with a protein content of 6.04 wt %, was then diafiltered on the same membrane with 150 L of RO water to which acid (typically HCl solution is used) was added to about pH 3, with this diafiltration operation conducted at about 54° C. The diafiltered protein solution was then adjusted to pH 7.04 by the addition of 0.42 kg of 25% NaOH. The pH adjusted protein solution was then diafiltered with 120 L of RO water at about 56° C. The diafiltered and concentrated protein solution had a protein content of 5.34 wt % and a pH of 7.10. A 24.20 kg portion of diafiltered protein solution was pasteurized at about 72° C. for 16 seconds. 23 kg of pasteurized solution was spray dried to yield a product having a protein content of 92.04% (N×6.25) d.b. The product was termed SF14-C24-22A SF871NL. Another 24.46 kg portion of diafiltered protein solution was jet cooked at 141° C. for about 45 seconds. 24.90 kg of jet cooked material was spray dried to yield a product having a protein content of 91.86 (N×6.25) d.b. The product was termed SF14-C24-22A SF871NLG.

The coarse solids collected by the decanter centrifuge had a protein content of 5.75 wt % and a solids content of 23.25 wt % (24.73% protein (N×6.25) d.b.).

Note all cited pH values were from measurements conducted with the sample at room temperature unless otherwise noted. The extraction slurry was noted as having a pH of 7.13 at 55.7° C.

### Example 9

30 kg of sunflower cake/meal (prepared by pressing sunflower kernels) was combined with 300 L of reverse osmosis purified (RO) water having a temperature of 60° C., 0.30 kg of ascorbic acid and 0.82 kg of 25% NaOH solution. The mixture was stirred for 15 minutes. A portion of the (coarse) suspended solids (72.0 kg) were removed by centrifugation using a decanter centrifuge to provide a protein solution having a protein content of 2.20 wt % and a pH of 7.30. This protein solution was then fed to a three-phase separator which removed an unrecorded weight of oil phase and 8.68 kg of suspended solids and provided 194 L of defatted protein solution having a protein content of 1.86 wt %. The suspended solids removed with the oil separator were re-combined with the defatted protein solution and pH of the mixture was adjusted to 2.90 by the addition of 1.58 kg of HCl solution (concentrated HCl diluted with one volume of RO water).

The acidified protein solution was then reduced in volume from 205 L to 50 L by concentration on a polyethersulfone membrane having a molecular weight cut-off of 10,000 daltons, operated at a temperature of about 50° C. The concentrated protein solution had a protein content of 6.72 wt % and a pH of 2.90. The concentrated protein solution was then adjusted to pH 7.27 by the addition of 0.78 kg of 25% NaOH. The pH adjusted protein solution was then pasteurized at about 72° C. for 16 seconds. 48.22 kg of pasteurized solution was spray dried to yield a product having a protein content of 78.65% (N×6.25) d.b. The product was termed SF15-C29-22A SF871N.

The coarse solids collected by the decanter centrifuge had a protein content of 5.82 wt % and a solids content of 18.78 wt % (30.99% protein (N×6.25) d.b.).

Note all cited pH values were from measurements conducted with the sample at room temperature unless otherwise noted.

### Example 10

30 kg of sunflower cake/meal (prepared by pressing sunflower kernels) was combined with 300 L of reverse osmosis purified (RO) water having a temperature of 60° C., 0.30 kg of ascorbic acid and an unrecorded amount of 25% NaOH solution. The mixture was stirred for 15 minutes. A portion of the suspended (coarse) solids (70.20 kg) were removed by centrifugation using a decanter centrifuge to provide a protein solution having a protein content of 2.26 wt % and a pH of 7.33. The protein solution was then fed to a three-phase separator which removed 33.74 kg of oil phase and 9.5 kg of suspended solids and provided 216 L of defatted protein solution having a protein content of 1.85 wt %. The pH of this solution was adjusted from 7.20 to 2.93 by the addition of 1.52 kg of HCl solution (concentrated HCl diluted with one volume of RO water).

The acidified protein solution was then reduced in volume from 216 L to 50 L by concentration on a polyethersulfone membrane having a molecular weight cut-off of 10,000 daltons, operated at a temperature of about 48° C. The protein solution, with a protein content of 9.28 wt %, was then diafiltered on the same membrane with 25 L of RO water. The diafiltered protein solution was then adjusted to pH 7.19 by the addition of 0.62 kg of 25% NaOH. The solution was then pasteurized at about 72° C. for 16 seconds. 45.50 kg of pasteurized solution was spray dried to yield a product having a protein content of 86.61% (N×6.25) d.b. The product was termed SF15-C30-22A SF871N.

The coarse solids collected by the decanter centrifuge had a protein content of 5.86 wt % and a solids content of 20.61 wt % (28.43% protein (N×6.25) d.b.).

Note all cited pH values were from measurements conducted with the sample at room temperature unless otherwise noted.

### Example 11

30 kg of sunflower cake/meal (prepared by pressing sunflower kernels) was combined with 300 L of reverse osmosis purified (RO) water having a temperature of 61° C., 0.30 kg of ascorbic acid and 0.74 kg of 25% NaOH solution. The mixture was stirred for 30 minutes. A portion of the suspended (coarse) solids (88.45 kg) were removed by centrifugation using a decanter centrifuge to provide a protein solution having a protein content of 2.83 wt % and a pH of 7.35. The protein solution was then further clarified by centrifugation using a disc stack centrifuge to remove additional suspended (finer) solids (7.83 kg) and provide a protein solution having a protein content of 2.46 wt %. The protein solution was then fed to a three-phase separator which removed 15.1 kg of oil phase and 10.0 kg of suspended solids and provided 190 L of defatted protein solution having a protein content of 2.31 wt %. The pH of this solution was adjusted from 7.30 to 2.94 by the addition of 1.48 kg of HCl solution.

The acidified protein solution was then reduced in volume from 190 L to 50 L by concentration on a polyethersulfone membrane having a molecular weight cut-off of 10,000 daltons, operated at a temperature of about 48° C. The protein solution, with a protein content of 6.07 wt %, was then diafiltered on the same membrane with 150 L of RO water, with this diafiltration operation conducted at about 51° C. The diafiltered protein solution was then adjusted to pH 7.28 by the addition of 0.52 kg of 25% NaOH. The pH adjusted protein solution was then diafiltered with another 100 L of RO water at about 50° C. The diafiltered protein solution had protein content of 6.22 wt % and a pH of 7.43. 50.70 kg of this solution was pasteurized at about 72° C. for 16 seconds. 50.50 kg of pasteurized solution was spray dried to yield a product having a protein content of 100.28% (N×6.25) d.b. The product was termed SF15-D04-22A SF871NL.

The coarse solids collected by the decanter centrifuge had a protein content of 6.86 wt % and a solids content of 16.49 wt % (41.60% protein (N×6.25) d.b.).

The finer solids collected by the disc stack centrifuge had a protein content of 10.54 wt % and a solids content of 16.95%. The dry basis protein content of this material was therefore 62.18 wt % (N×6.25).

Note all cited pH values were from measurements conducted with the sample at room temperature unless otherwise noted.

### Example 12

[00212]30 kg of sunflower cake/meal (prepared by separately pressing sunflower kernels and black oil sunflower seeds, grinding the presscake from the seed, then combining the materials in a 80:20 ratio) was combined with 300 L of reverse osmosis purified (RO) water having a temperature of 60° C., 0.30 kg of ascorbic acid and 0.8 kg of 25% NaOH solution. The mixture was stirred for 15 minutes. A portion of the suspended (coarse) solids (87.62 kg) were removed by centrifugation using a decanter centrifuge to provide a protein solution having a protein content of 2.49 wt % and a pH of 7.41. The protein solution was then further clarified by centrifugation using a disc stack centrifuge to remove additional suspended (finer) solids (9.52 kg) and provide a protein solution having a protein content of 2.02 wt %. The protein solution was then fed to a three-phase separator which removed 34.44 kg of oil phase and 8.90 kg of suspended solids and provided 180 L of defatted protein solution having a protein content of 1.92 wt %. The pH of this solution was adjusted from 7.19 to 3.05 by the addition of 1.18 kg of HCl solution (concentrated HCl diluted with one volume of RO water).

The acidified protein solution was then reduced in volume from 180 L to 40 L by concentration on a polyethersulfone membrane having a molecular weight cut-off of 10,000 daltons, operated at a temperature of about 47° C. The protein solution, with a protein content of 6.16 wt %, was then diafiltered on the same membrane with 120 L of RO water, with this diafiltration operation conducted at about 51° C. The diafiltered protein solution was then adjusted to pH 7.18 by the addition of 0.45 kg of 25% NaOH. The pH adjusted protein solution was then diafiltered with another 100 L of RO water at about 52° C. The diafiltered protein solution had protein content of 5.21 wt % and a pH of 7.35. 49.40 kg of this solution was pasteurized at about 72° C. for 16 seconds. 46.13 kg of pasteurized solution was spray dried to yield a product having a protein content of 97.93% (N×6.25) d.b. The product was termed SF16-D05-22A SF871NL.

The coarse solids collected by the decanter centrifuge had a protein content of 6.10 wt % and a solids content of 17.48 wt % (34.90% protein (N×6.25) d.b.).

The finer solids collected by the disc stack centrifuge had a protein content of 9.13 wt % and a solids content of 15.77%. The dry basis protein content of this material was therefore 57.89 wt % (N×6.25).

Note all cited pH values were from measurements conducted with the sample at room temperature unless otherwise noted.

### Example 13

[00217]30 kg of sunflower cake/meal (prepared by pressing sunflower kernel coarse chips) was combined with 300 L of reverse osmosis purified (RO) water having a temperature of 60° C., 0.30 kg of ascorbic acid and 0.8 kg of 25% NaOH solution. The mixture was stirred for 15 minutes. A portion of the suspended (coarse) solids (95.52 kg) were removed by centrifugation using a decanter centrifuge to provide a protein solution having a protein content of 3.01 wt % and a pH of 7.47. The protein solution was then further clarified by centrifugation using a disc stack centrifuge to remove additional suspended (finer) solids (8.20 kg) and provide a protein solution having a protein content of 2.57 wt %. The protein solution was then fed to a three-phase separator which removed 29.19 kg of oil phase and 8.61 kg of suspended solids and provided 190 L of defatted protein solution having a protein content of 2.39 wt %. The pH of this solution was adjusted from 7.31 to 2.97 by the addition of 1.52 kg of HCl solution (concentrated HCl diluted with one volume of RO water).

The acidified protein solution was then reduced in volume from 190 L to 50 L by concentration on a polyethersulfone membrane having a molecular weight cut-off of 10,000 daltons, operated at a temperature of about 48° C. The protein solution, with a protein content of 6.90 wt %, was then diafiltered on the same membrane with 150 L of RO water, with this diafiltration operation conducted at about 52° C. The diafiltered protein solution was then adjusted to pH 7.17. The pH adjusted protein solution was then diafiltered with another 120 L of RO water at about 52° C. then further concentrated to a protein content of 9.57 wt %. This diafiltered and concentrated protein solution had a pH of 7.26. This solution was pasteurized at about 72° C. for 16 seconds. 28.4 kg of pasteurized solution was spray dried to yield a product having a protein content of 100.90% (N×6.25) d.b. The product was termed SF17-D06-22A SF871NL.

The coarse solids collected by the decanter centrifuge had a protein content of 6.81 wt % and a solids content of 15.75 wt % (43.24% protein (N×6.25) d.b.).

The finer solids collected by the disc stack centrifuge had a protein content of 9.46 wt % and a solids content of 14.96%. The dry basis protein content of this material was therefore 63.24% (N×6.25).

Note all cited pH values were from measurements conducted with the sample at room temperature unless otherwise noted.

### Example 14

[00222]30 kg of sunflower cake/meal (prepared by pressing sunflower kernels) was combined with 300 L of reverse osmosis purified (RO) water having a temperature of 64.9 C, 0.30 kg of ascorbic acid and 0.96 kg of 25% NaOH solution. The mixture was stirred for 15 minutes. A portion of the suspended (coarse) solids (52.20 kg) were removed by centrifugation using a decanter centrifuge to provide a protein solution having a protein content of 2.55 wt % and a pH of 7.15. The protein solution was then further clarified by centrifugation using a disc stack centrifuge to remove additional suspended (finer) solids (8.36 kg) and provide a protein solution having a protein content of 2.36 wt %. The protein solution was then fed to a three-phase separator which removed 12.46 kg of oil phase and 8.76 kg of suspended solids and provided 250 L of defatted protein solution having a protein content of 2.28 wt %. The pH of this solution was adjusted from 7.06 to 2.82 by the addition of 1.88 kg of HCl solution (concentrated HCl diluted with one volume of RO water).

The acidified protein solution was then reduced in volume from 250 L to 65 L by concentration on a polyethersulfone membrane having a molecular weight cut-off of 100,000 daltons, operated at a temperature of about 46° C. The protein solution, with a protein content of 7.62 wt %, was then diafiltered on the same membrane with 195 L of RO water, with this diafiltration operation conducted at about 49° C. The diafiltered protein solution was then adjusted to pH 7.09 by the addition of 0.60 kg of 25% NaOH. The pH adjusted protein solution was then diafiltered with another 130 L of RO water at about 50° C. then further concentrated to a protein content of 11.12 wt %. The membrane system was flushed with water and the flush water added to the diafiltered and concentrated protein solution. 44.67 kg of this solution was pasteurized at 72° C. for 16 seconds. The pasteurized solution had a protein content of 8.68 wt % and a pH of 7.24. 43.74 kg of pasteurized solution was spray dried to yield a product having a protein content of 103.77% (N×6.25) d.b. The product was termed SF15-D20-22A SF871NL.

The coarse solids collected by the decanter centrifuge had a protein content of 11.33 wt % and a solids content of 26.36 wt % (42.98% protein (N×6.25) d.b.).

The finer solids collected by the disc stack centrifuge had an as-is protein content of 6.89 wt % and a solids content of 12.12%. The dry basis protein content of this material was therefore 56.85% (N×6.25).

Note all cited pH values were from measurements conducted with the sample at room temperature unless otherwise noted. The extraction slurry was noted as having a pH of 7.07 at 61° C.

### Example 15

[00227]30 kg of sunflower cake/meal (prepared by pressing sunflower kernel coarse chips) was combined with 300 L of reverse osmosis purified (RO) water having a temperature of 62° C., 0.30 kg of ascorbic acid and 0.741 kg of NaOH solution. The mixing time was not recorded. Typically, mixing time is between 10 and 30 minutes. A portion of the suspended (coarse) solids (49.25 kg) were removed by centrifugation using a decanter centrifuge to provide a protein solution having a protein content of 2.60 wt % and a pH of 7.34. The protein solution was then further clarified by centrifugation using a disc stack centrifuge to remove additional suspended (finer) solids (7.45 kg) and provide a protein solution having a protein content of 2.36 wt %. The protein solution was then fed to a three-phase separator which removed 10.83 kg of oil phase and 9.92 kg of suspended solids and provided 260 L of defatted protein solution having a protein content of 2.19 wt %. The pH of this solution was adjusted from 7.23 to 2.97 by the addition of 1.98 kg of HCl solution (concentrated HCl diluted with one volume of RO water).

The acidified protein solution was then reduced in volume from 260 L to 80 L by concentration on a polyethersulfone membrane having a molecular weight cut-off of 100,000 daltons, operated at a temperature of about 46° C. The protein solution, with a protein content of 6.49 wt %, was adjusted to pH 7.13 by the addition of 1.1 kg of 25% NaOH. The pH adjusted protein solution was then diafiltered with 80 L of RO water at about 50° C. The diafiltered protein solution was then further concentrated to a protein content of 7.85 wt %. This solution had a pH of 7.23. 43.24 kg of this solution was pasteurized at 72° C. for 16 seconds. 41.44 kg of pasteurized solution was spray dried to yield a product having a protein content of 95.52% (N×6.25) d.b. The product was termed SF17-D26-22A SF871NL.

The coarse solids collected by the decanter centrifuge had a protein content of 9.45 wt % and a solids content of 24.57 wt % (38.46% protein (N×6.25) d.b.).

The finer solids collected by the disc stack centrifuge had an as-is protein content of 9.17 wt % and a solids content of 17.17%. The dry basis protein content of this material was therefore 53.41% (N×6.25).

Note all cited pH values were from measurements conducted with the sample at room temperature unless otherwise noted. The extraction slurry was noted as having a pH of 7.18 at 58.6° C.

### Example 16

30 kg of sunflower cake/meal (prepared by pressing sunflower kernel coarse chips) was combined with 300 L of reverse osmosis purified (RO) water having a temperature of 63.5° C., 0.30 kg of ascorbic acid and 0.640 kg of 25% NaOH solution. The mixture was stirred for 15 minutes. A portion of the suspended (coarse) solids (57.19 kg) were removed by centrifugation using a decanter centrifuge to provide a protein solution having a protein content of 2.56 wt % and a pH of 7.24. The protein solution was then further clarified by centrifugation using a disc stack centrifuge to remove additional suspended (finer) solids (7.40 kg) and provide a protein solution having a protein content of 2.23 wt %. The protein solution was then fed to a three-phase separator which removed 7.16 kg of oil phase and 8.30 kg of suspended solids and provided 265 L of defatted protein solution having a protein content of 2.20 wt %. The pH of this solution was adjusted from 7.05 to 2.99 by the addition of 1.90 kg of HCl solution (concentrated HCl diluted with one volume of RO water).

The acidified protein solution was then reduced in volume from 265 L to 75 L by concentration on a polyethersulfone membrane having a molecular weight cut-off of 100,000 daltons, operated at a temperature of about 49° C. The protein solution, with a protein content of 6.83 wt %, was then diafiltered on the same membrane with 225 L of RO water, with this diafiltration operation conducted at about 51° C. The diafiltered protein solution was then adjusted to pH 7.08 by the addition of 0.68 kg of 25% NaOH. The pH adjusted protein solution was then diafiltered with another 150 L of RO water at about 32° C. The diafiltered protein solution was then further concentrated to a protein content of 9.29 wt %. This solution had a pH of 7.06. 49.38 kg of this solution was pasteurized at about 72° C. for 16 seconds. 47.7 kg of pasteurized solution was spray dried to yield a product having a protein content of 101.86% (N×6.25) d.b. The product was termed SF17-E02-22A SF871NL.

The coarse solids collected by the decanter centrifuge had a protein content of 10.61 wt % and a solids content of 25.99 wt % (40.82% protein (N×6.25) d.b.).

The finer solids collected by the disc stack centrifuge had an as-is protein content of 8.39 wt % and a solids content of 15.95%. The dry basis protein content of this material was therefore 52.60 wt % (N×6.25).

Note all cited pH values were from measurements conducted with the sample at room temperature unless otherwise noted. The extraction slurry was noted as having a pH of 7.09 at 61.9° C.

### Example 17

[00237]30 kg of sunflower cake/meal (prepared by pressing sunflower kernel medium chips) was combined with 300 L of reverse osmosis purified (RO) water having a temperature of 62.8° C., 0.30 kg of ascorbic acid and 0.720 kg of NaOH solution. The mixture was stirred for 10 minutes. A portion of the suspended (coarse) solids (60.65 kg) were removed by centrifugation using a decanter centrifuge to provide a protein solution having a protein content of 2.83 wt % and a pH of 7.37. The protein solution was then further clarified by centrifugation using a disc stack centrifuge to remove additional suspended (finer) solids (9.78 kg) and provide a protein solution having a protein content of 2.54 wt %. The protein solution was then fed to a three-phase separator which removed 7.14 kg of oil phase and 8.32 kg of suspended solids and provided 252 L of defatted protein solution having a protein content of 2.32 wt %. The pH of this solution was adjusted from 7.29 to 3.03 by the addition of 2.00 kg of HCl solution (concentrated HCl diluted with one volume of RO water).

The acidified protein solution was then reduced in volume from 252 L to 75 L by concentration on a polyvinylidene difluoride (PVDF) membrane having a molecular weight cut-off of 70,000 daltons, operated at a temperature of about 47° C. The protein solution, with a protein content of 7.22 wt %, was then diafiltered on the same membrane with 225 L of RO water, with this diafiltration operation conducted at about 50° C. The diafiltered protein solution was then adjusted to pH 7.00 by the addition of 0.62 kg of 25% NaOH. The pH adjusted protein solution was then diafiltered with another 150 L of RO water at about 52° C. The diafiltered protein solution was then further concentrated to a protein content of 8.11 wt %. This solution had a pH of 7.28. 38.04 kg of this solution was pasteurized at about 72° C. for 16 seconds. 36.52 kg of pasteurized solution was spray dried to yield a product having a protein content of 103.53% (N×6.25) d.b. The product was termed SF18-E04-22A SF871NL.

The coarse solids collected by the decanter centrifuge had a protein content of 9.37 wt % and a solids content of 23.11 wt % (40.54% protein (N×6.25) d.b.).

The finer solids collected by the disc stack centrifuge had an as-is protein content of 5.70 wt % and a solids content of 10.40%. The dry basis protein content of this material was therefore 54.81 wt % (N×6.25).

Note all cited pH values were from measurements conducted with the sample at room temperature unless otherwise noted.

### Example 18

[00242]30 kg of sunflower flour/meal (partially defatted, made from kernels) was combined with 300 L of reverse osmosis purified (RO) water having a temperature of 62° C., 0.30 kg of ascorbic acid and 0.68 kg of 25% NaOH solution. The mixture was stirred for 10 minutes. A portion of the suspended (coarse) residual solids (47.18 kg) were removed by centrifugation using a decanter centrifuge to provide a protein solution having a protein content of 2.99 wt % and a pH of 7.43. The protein solution was then further clarified by centrifugation using a disc stack centrifuge to remove additional suspended (finer) residual solids (13.88 kg) and provide 272 L of protein solution having a protein content of 2.58 wt %. The protein solution was then fed to a three-phase separator which removed 8.36 kg of oil phase and 14.44 kg of suspended solids and provided a defatted protein solution having a protein content of 2.41 wt %. The pH of this solution was adjusted from 7.31 to 3.01 by the addition of 0.96 kg of HCl solution (concentrated HCl diluted with an equal volume of RO water).

The acidified protein solution was then reduced in volume from 265 L to 70 L by concentration on a polyethersulfone membrane having a molecular weight cut-off of 100,000 daltons, operated at a temperature of about 47° C. The protein solution, with a protein content of 7.55 wt %, was then diafiltered on the same membrane with 210 L of RO water, with this diafiltration operation conducted at about 51° C. The diafiltered protein solution was then adjusted to pH 7.15 by the addition of 0.84 kg of 25% NaOH. The pH adjusted protein solution was then diafiltered with 150 L of RO water at about 52° C. and further concentrated to a protein content of 12.22 wt %. This diafiltered and concentrated protein solution had a pH of 7.18. 14.30 kg of this material was collected. Additional diluted retentate was obtained by flushing the membrane system with an unrecorded volume of water. This diluted sample had a protein content of 7.69% and a pH of 7.26. 14.30 kg of undiluted, diafiltered and concentrated protein solution was pasteurized at 72° C. for 16 seconds. 11.54 kg of this pasteurized solution was spray dried to yield a product having a protein content of 97.44% (N×6.25) d.b. The product was termed SF19-F01-22A SF871NL-01. 32.40 kg of the diluted, diafiltered and concentrated protein solution was pasteurized at 72° C. for 16 seconds. 33.84 kg of this pasteurized solution was spray dried to yield a product having a protein content of 97.27% (N×6.25) d.b. The product was termed SF19-F01-22A SF871NL-02.

The coarse residual solids removed by the decanter centrifuge had a protein content of 10.18 wt % and a solids content of 22.71 wt % (44.83% protein (N×6.25) d.b.).

The 13.88 kg of finer solids collected by the disc stack centrifuge was pasteurized at about 73° C. for 5 minutes. 13.14 kg of pasteurized material was spray dried to yield a product having a protein content of 55.77 (N×6.25) d.b. The product was termed SF19-F01-22A SF871PN.

Note all cited pH values were from measurements conducted with the sample at room temperature unless otherwise noted. The extraction slurry was noted as having a pH of 7.08 at 47° C.

### Example 19

30 kg of sunflower flour/meal (partially defatted, made from kernels) was combined with 300 L of reverse osmosis purified (RO) water having a temperature of 62.1° C. and 0.66 kg of 25% NaOH solution. The mixture was stirred for 10 minutes. A portion of the suspended (coarse) residual solids (50.55 kg) were removed by centrifugation using a decanter centrifuge to provide a protein solution having a protein content of 3.17 wt % and a pH of 7.45. The protein solution was then further clarified by centrifugation using a disc stack centrifuge to remove additional suspended (finer) residual solids (15.74 kg) and provide 268 L of protein solution having a protein content of 2.82 wt %. The protein solution was then fed to a three-phase separator which removed 7.79 kg of oil phase and 13.88 kg of suspended solids and provided a defatted protein solution having a protein content of 2.70 wt %. The pH of this solution was adjusted from 7.36 to 3.04 by the addition of 1.92 kg of HCl solution (concentrated HCl diluted with an equal volume of RO water).

The acidified protein solution was then reduced in volume from 265 L to 80 L by concentration on a polyethersulfone membrane having a molecular weight cut-off of 100,000 daltons, operated at a temperature of about 47° C. The protein solution, with a protein content of 7.25 wt %, was then diafiltered on the same membrane with 240 L of RO water, with this diafiltration operation conducted at about 52° C. The diafiltered protein solution was then adjusted to pH 7.24 by the addition of 0.82 kg of 25% NaOH. The pH adjusted protein solution was then diafiltered with 160 L of RO water at about 51° C. and further concentrated to a protein content of 12.00 wt %. This diafiltered and concentrated protein solution had a pH of 7.28. 22.16 kg of this material was collected. Additional diluted retentate was obtained by flushing the membrane system with an unrecorded volume of water. This diluted sample had a protein content of 8.26% and a pH of 7.40. 22.16 kg of undiluted, diafiltered and concentrated protein solution was pasteurized at 72° C. for 16 seconds. 20.20 kg of this pasteurized solution was spray dried to yield a product having a protein content of 96.96% (N×6.25) d.b. The product was termed SF19-F02-22A SF871NL-01. 31.16 kg of the diluted, diafiltered and concentrated protein solution was pasteurized at 72° C. for 16 seconds. 31.84 kg of this pasteurized solution was spray dried to yield a product having a protein content of 95.63% (N×6.25) d.b. The product was termed SF19-F02-22A SF871NL-02.

The coarse residual solids removed by the decanter centrifuge had a protein content of 9.30 wt % and a solids content of 21.09 wt % (44.10% protein (N×6.25) d.b.).

The 15.74 kg of finer solids collected by the disc stack centrifuge was diluted with 3 kg of RO water and pasteurized at about 72° C. for 7 minutes. An additional 2 L of RO flush water was added while draining the product. 19.92 kg of pasteurized material was spray dried to yield a product having a protein content of 57.86 (N×6.25) d.b. The product was termed SF19-F02-22A SF871PN.

Note all cited pH values were from measurements conducted with the sample at room temperature unless otherwise noted. The extraction slurry was noted as having a pH of 7.18 at 52° C.

### Example 20

30 kg of sunflower flour/meal (partially defatted, made from kernels) was combined with 300 L of reverse osmosis purified (RO) water having a temperature of 63.4° C., 0.30 kg of ascorbic acid and 1.18 kg of 25% NaOH solution. The mixture was stirred for 15 minutes. A portion of the (coarse) suspended solids (42.83 kg) were removed by centrifugation using a decanter centrifuge to provide a protein solution having a protein content of 3.37 wt % and a pH of 7.23. The protein solution was then further clarified by centrifugation using a disc stack centrifuge to remove additional suspended (finer) solids (17.46 kg) and provide 264.8 L of protein solution having a protein content of 3.02 wt %. The protein solution was then fed to a three-phase separator which removed 4.22 kg of oil phase and 10.22 kg of suspended solids and provided 260 L of defatted protein solution having a protein content of 2.74 wt %. The pH of this solution was adjusted from 7.14 to 2.96 by the addition of 2.22 kg of HCl solution (concentrated HCl diluted with an equal volume of RO water).

The acidified protein solution was then reduced in volume from 260 L to 90 L by concentration on a polyethersulfone membrane having a molecular weight cut-off of 100,000 daltons, operated at a temperature of about 48° C. The protein solution, with a protein content of 7.38 wt %, was then diafiltered on the same membrane with 270 L of RO water, with this diafiltration operation conducted at about 52° C. The diafiltered protein solution was then adjusted to pH 7.38 by the addition of 1.72 kg of 25% NaOH. The pH adjusted protein solution was then diafiltered with 180 L of RO water at about 51° C. and further concentrated to a protein content of 12.01 wt %. This diafiltered and concentrated protein solution had a pH of 7.38. 33.92 kg of this solution was pasteurized at about 72° C. for 1 minute. 31.50 kg of this pasteurized solution was spray dried to yield a product having a protein content of 101.86% (N×6.25) d.b. The product was termed SF21-F23-22A SF871NL.

7.5 kg of coarse solids captured by the decanter centrifuge were diluted with 10 L of RO water and spray dried to yield a product with a protein content of 50.63% (N×6.25) d.b. The product was termed SF21-F23-22A SF871SM.

The 17.46 kg of finer solids collected by the disc stack centrifuge was pasteurized at about 72° C. for 1 minute. Some dilution with flush water occurred during the pasteurization step. 21.70 kg of pasteurized material was spray dried to yield a product having a protein content of 52.06% (N×6.25) d.b. The product was termed SF21-F23-22A SF871PN.

Note all cited pH values were from measurements conducted with the sample at room temperature unless otherwise noted.

### Example 21

30 kg of sunflower flour (partially defatted, made from kernels) was combined with 300 L of reverse osmosis purified (RO) water having a temperature of 61° C., 0.30 kg of ascorbic acid and 1.3 kg of 25% NaOH solution. The mixture was stirred for 15 minutes. A portion of the suspended solids (91.12 kg) were removed by centrifugation using a decanter centrifuge to provide a protein solution having a protein content of 3.65 wt % and a pH of 7.42. The protein solution was then further clarified by centrifugation using a disc stack centrifuge to remove additional suspended (finer) solids (11.08 kg) and provide a protein solution having a protein content of 3.09 wt %. The protein solution was then fed to a three-phase separator which removed 5.08 kg of oil phase and 10.44 kg of suspended solids and provided a defatted protein solution having a protein content of 2.71 wt %. The pH of the defatted solution was adjusted from 7.33 to 3.06 by the addition of 1.78 kg of HCl solution (concentrated HCl diluted with an equal volume of RO water)

The acidified protein solution was reduced in volume from 230 L to 80 L by concentration on a polyethersulfone membrane having a molecular weight cut-off of 100,000 daltons, operated at a temperature of about 48° C. The protein solution, with a protein content of 6.45 wt %, was then diafiltered on the same membrane with 80 L of RO water, with this diafiltration operation conducted at about 51° C. The diafiltered protein solution was adjusted to pH 7.36 by the addition of 25% NaOH then diluted with about 80 L of RO water for batchwise diafiltration. This solution was then concentrated on the same membrane to a protein content of 7.46 wt %. This diafiltered and concentrated protein solution had a pH of 7.44. 33.78 kg of diafiltered and concentrated protein solution was pasteurized at 72° C. for 16 seconds. 33.24 kg of pasteurized solution was spray dried to yield a product having a protein content of 94.66% (N×6.25) d.b. The product was termed SF19-F27-22A SF871NL.

The coarse residual solids removed by the decanter centrifuge had a protein content of 8.03 wt % and a solids content of 16.30 wt % (49.26% protein (N×6.25) d.b.).

The finer solids captured by the disc stack centrifuge had a protein content of 11.13 wt %. These were pasteurized at 72-73° C. for 1 minute. The pasteurized solids were spray dried to provide a product with a protein content of 61.97% (N×6.25) d.b. The product was termed SF19-F27-22A SF871PN.

Note all cited pH values were from measurements conducted with the sample at room temperature unless otherwise noted. The extraction slurry was noted as having a pH of 7.1 at 60° C.

### Example 22

Sunflower flour/meal (partially defatted, made from kernels) was combined with reverse osmosis purified (RO) water, ascorbic acid and 25% NaOH solution in 5 lots as detailed in Table 1 below.

TABLE 1
Details of extraction slurries for preparation of SF25-I07-22A products

| | Wt. | Vol. RO | Temp. RO | Wt. | Wt. 25% | |
|---|---|---|---|---|---|---|
| | presscake | water | water | ascorbic | NaOH solution | Slurry pH |
| lot | (kg) | (L) | (° C.) | acid (kg) | (kg) | measurement |
| 1 | 30 | 300 | 66.0 | 0.30 | 0.710 | 7.10 at 60.5° C. |
| 2 | 30 | 300 | 66.0 | 0.30 | 0.710 | 7.12 at 61.1° C. |
| 3 | 30 | 300 | 65.5 | 0.30 | 0.710 | 7.09 at 60.1° C. |
| 4 | 30 | 300 | 63.9 | 0.30 | 0.700 | 7.11 at 59.8° C. |
| 5 | 30 | 300 | 65.1 | 0.30 | 0.705 | 7.09 at 61.1° C. |

The mixtures were stirred for 15 minutes. A portion of the suspended (coarse) solids (307.70 kg) were removed by centrifugation using a decanter centrifuge to provide a protein solution having a protein content of 4.21 wt % and a pH of 7.38. The protein solution was then further clarified by centrifugation using a disc stack centrifuge to remove additional suspended (finer) solids (134.9 kg) and provide 1145 L of protein solution having a protein content of 3.45 wt %. The protein solution was then fed to a three-phase separator which removed 14.72 kg of oil phase and 10.94 kg of suspended solids and provided 1100 L of defatted protein solution having a protein content of 3.25 wt %. The pH of this solution was adjusted from 7.15 to 3.02 by the addition of 10.46 L of HCl solution (concentrated HCl diluted with one volume of RO water).

The acidified protein solution was then reduced in volume from 1100 L to 390 L by concentration on a polyethersulfone membrane having a molecular weight cut-off of 10,000 daltons, operated at a temperature of about 58° C. The protein solution, with a protein content of 10.21 wt %, was then diafiltered on the same membrane with 780 L of RO water, with this diafiltration operation conducted at about 60° C. The diafiltered protein solution was then adjusted to pH 7.24 by the addition of 4.3 kg of 25% NaOH. The pH adjusted protein solution was then diafiltered with 800 L of RO water at about 59° C. and further concentrated to a volume of 270 L. Flushing the system with water resulted in 310 kg of diluted, diafiltered and concentrated protein solution having a protein content of 9.08 wt %, which was pasteurized at 72° C. for 16 seconds. 270 L of this pasteurized solution was spray dried to yield a product having a protein content of 100.58% (N×6.25) d.b. The product was termed SF25-I07-22A SF871NL.

The coarse residual solids captured by the decanter centrifuge had a protein content of 9.79 wt % and a solids content of 19.06 wt % (51.36% protein (N×6.25) d.b.).

A sample of the finer solids collected by the disc stack centrifuge was freeze dried to provide a product having an as-is protein content of 56.35% (N×6.25) d.b. The product was termed SF25-I07-22A SF871PN.

### Example 23

30 kg of sunflower flour/meal (partially defatted, made from kernels) was combined with 300 L of reverse osmosis purified (RO) water having a temperature of 62.1° C., 0.30 kg of ascorbic acid and 0.75 kg of 25% NaOH solution. The mixture was stirred for 10 minutes. A portion of the suspended (coarse) solids (60.81 kg) were removed by centrifugation using a decanter centrifuge to provide a protein solution having a protein content of 3.64 wt % and a pH of 7.28. The protein solution was then further clarified by centrifugation using a disc stack centrifuge to remove additional suspended (finer) solids (18.95 kg) and provide 267 L of protein solution having a protein content of 2.80 wt %. The protein solution was then fed to a three-phase separator which removed 2.5 kg of oil phase and 10.5 kg of suspended solids and provided a defatted protein solution having a protein content of 2.46 wt %. The pH of this solution was adjusted from 7.21 to 3.00 by the addition of 2.28 kg of HCl solution (concentrated HCl diluted with an equal volume of RO water).

The finer solids collected by the disc stack centrifuge were washed by combining them with 76 L of RO water having a temperature of 60° C. The mixture was run through the disc stack centrifuge again and 15.14 kg of washed finer solids were collected along with 90 L of used wash solution (centrate) having a protein content of 0.74 wt % and a pH of 7.64.

The acidified protein solution was reduced in volume from 245 L to 75 L by concentration on a polyethersulfone membrane having a molecular weight cut-off of 100,000 daltons, operated at a temperature of about 51° C. The protein solution, with a protein content of 6.37 wt %, was then diafiltered on the same membrane with 150 L of RO water, with this diafiltration operation conducted at about 56° C. The diafiltered protein solution was combined with the 90 L of used wash solution and the pH of the mixture adjusted to pH 7.04 by the addition of 0.75 kg of 25% NaOH. The pH adjusted protein solution was reduced in volume to 90 L on the same membrane as utilized for the initial concentration, operated at a temperature of about 53° C., then diafiltered with 180 L of RO water at about 57° C. and further concentrated to a protein content of 9.17 wt %. This diafiltered and concentrated protein solution had a pH of 7.11. 50.84 kg of this material was pasteurized at about 73° C. for 16 seconds. 49.08 kg of this pasteurized solution was spray dried to yield a product having a protein content of 94.13% (N×6.25) d.b. The product was termed SF24-I22-22A SF871NL.

The coarse residual solids removed by the decanter centrifuge had a protein content of 7.39 wt % and a solids content of 17.36 wt % (42.57% protein (N×6.25) d.b.).

The 15.14 kg of washed finer solids were pasteurized at about 72° C. for 5 minutes. 14.00 kg of pasteurized material was spray dried to yield a product having a protein content of 53.24 (N×6.25) d.b. The product was termed SF24-I22-22A SF871PN.

Note all cited pH values were from measurements conducted with the sample at room temperature unless otherwise noted. The extraction slurry was noted as having a pH of 7.06 at 49.3° C.

### Example 24

30 kg of sunflower flour/meal (partially defatted, made from kernels) was combined with 300 L of reverse osmosis purified (RO) water having a temperature of 60.9° C., 0.30 kg of ascorbic acid and 0.72 kg of 25% NaOH solution. The mixture was stirred for and unrecorded time. Mixing times are typically 10-30 minutes. A portion of the suspended (coarse) solids (39.28 kg) were removed by centrifugation using a decanter centrifuge to provide a protein solution having a protein content of 3.33 wt % and a pH of 7.32. The protein solution was then further clarified by centrifugation using a disc stack centrifuge to remove additional suspended (finer) solids (22.26 kg) and provide 265 L of protein solution having a protein content of 2.99 wt %. The protein solution was then fed to a three-phase separator which removed 5.28 kg of oil phase and 10.82 kg of suspended solids and provided 240 L of defatted protein solution having a protein content of 2.63 wt %. The pH of this solution was adjusted from 7.12 to 2.97 by the addition of 1.14 kg of HCl solution (concentrated HCl diluted with an equal volume of RO water).

The finer solids collected by the disc stack centrifuge were washed by combining them with about 90 L of RO water having a temperature of 60° C. The mixture was run through the disc stack centrifuge again and 15.5 kg of washed finer solids were collected along with 90 L of used wash solution (centrate) having a protein content of 0.89 wt % and a pH of 7.58.

The acidified protein solution was reduced in volume from 240 L to 75 L by concentration on a polyethersulfone membrane having a molecular weight cut-off of 100,000 daltons, operated at a temperature of about 50° C. The protein solution, with a protein content of 6.54 wt %, was then diafiltered on the same membrane with 150 L of RO water, with this diafiltration operation conducted at about 54° C. The diafiltered protein solution was combined with the 90 L of used wash solution and the pH of the mixture adjusted to pH 7.11 by the addition of 0.78 kg of 25% NaOH. The pH adjusted protein solution was reduced in volume to 90 L on the same membrane as utilized for the initial concentration, operated at a temperature of about 56° C., then diafiltered with 180 L of RO water at about 60° C. and further concentrated to a protein content of 9.24 wt %. This diafiltered and concentrated protein solution had a pH of 7.22. 43.12 kg of this material was pasteurized at about 72° C. for 1 minute. 41.2 kg of pasteurized solution was spray dried to yield a product having a protein content of 93.78% (N×6.25) d.b. The product was termed SF24-I26-22A SF871NL.

25 kg of the coarse solids removed by the decanter centrifuge were diluted with water and spray dried to yield a product with a protein content of 42.74% (N×6.25) d.b. The product was termed SF24-I26-22A SF871SM.

The washed finer solids had a protein content of 7.43 wt % and a solids content of 14.97 wt % (49.63% protein (N×6.25) d.b.)

Note all cited pH values were from measurements conducted with the sample at room temperature unless otherwise noted. The extraction slurry was noted as having a pH of 7.02 at 61.2° C.

### Example 25

30 kg of sunflower flour/meal (partially defatted, made from kernels) was combined with 300 L of reverse osmosis purified (RO) water having a temperature of 62.9° C., 0.30 kg of ascorbic acid and 0.74 kg of 25% NaOH solution. The mixture was stirred for 15 minutes. A portion of the suspended solids (71.60 kg) were removed by centrifugation using a decanter centrifuge to provide a protein solution having a protein content of 3.76 wt % and a pH of 7.42. The protein solution was then further clarified by centrifugation using a disc stack centrifuge to remove additional suspended (finer) solids (16.18 kg) and provide 243 L of protein solution having a protein content of 3.27 wt %. The protein solution was then fed to a three-phase separator which removed 3.04 kg of oil phase and 10.68 kg of suspended solids and provided 230 L of defatted protein solution having a protein content of 3.06 wt %. The pH of this solution was adjusted from 7.29 to 3.01 by the addition of 2.28 kg of HCl solution (concentrated HCl diluted with an equal volume of RO water).

The finer solids collected by the disc stack centrifuge were washed by combining them with 65 L of RO water having a temperature of about 60° C. The mixture was run through the disc stack centrifuge again and 4.02 kg of washed finer solids were collected along with 90 L of used wash solution (centrate) having a protein content of 0.57 wt % and a pH of 7.67.

The acidified protein solution was reduced in volume from 230 L to 85 L by concentration on a polyethersulfone membrane having a molecular weight cut-off of 100,000 daltons, operated at a temperature of about 47° C. The protein solution, with a protein content of 7.44 wt %, was then diafiltered on the same membrane with 170 L of RO water, with this diafiltration operation conducted at about 58° C. The diafiltered protein solution was combined with the 90 L of used wash solution and the pH of the mixture adjusted to pH 7.09 by the addition of 0.90 kg of 25% NaOH. The pH adjusted protein solution was diafiltered on the same membrane with 360 L of RO water at about 60° C. and further concentrated to a protein content of 8.51 wt %. This diafiltered and concentrated protein solution had a pH of 7.23. 56.84 kg of this material was pasteurized at 72° C. for 16 seconds. 55.5 kg of pasteurized solution was spray dried to yield a product having a protein content of 98.18% (N×6.25) d.b. The product was termed SF19/23-J11-22A SF871NL.

The coarse solids removed by the decanter centrifuge had a protein content of 9.41 wt % and solids content of 18.89 wt % (49.81% protein (N×6.25) d.b.).

The washed finer solids had a protein content of 10.28 wt % and solids content of 16.67 wt % (61.67% protein (N×6.25) d.b.). 61.58 kg of the coarse solids were combined with 3.45 kg of the washed finer solids and the mixture diluted with about 130 L of RO water then spray dried to yield a product with a protein content of 47.13% (N×6.25) d.b. The product was termed SF19/23-J11-22A SF871PC.

Note all cited pH values were from measurements conducted with the sample at room temperature unless otherwise noted. The extraction slurry was noted as having a pH of 7.1 at 60.3° C.

### Example 26

30 kg of sunflower flour/meal (partially defatted, made from kernels) was combined with 300 L of reverse osmosis purified (RO) water having a temperature of 66.7° C., 0.30 kg of ascorbic acid and 0.66 kg of 25% NaOH solution. The mixture was stirred for an unrecorded time. Typical mixing times are 10 to 30 minutes. A portion of the suspended solids (88.6 kg) were removed by centrifugation using a decanter centrifuge to provide a protein solution having a protein content of 3.48 wt % and a pH of 7.31. The protein solution was then further clarified by centrifugation using a disc stack centrifuge to remove additional suspended (finer) solids (15.50 kg) and provide 210 L of protein solution having a protein content of 2.76 wt %. The protein solution was then fed to a three-phase separator which removed 5.19 kg of oil phase and 9.94 kg of suspended solids and provided 210 L of defatted protein solution having a protein content of 2.67 wt %. The pH of the defatted solution was adjusted from 7.21 to 2.93 by the addition of 1.75 kg of HCl solution (concentrated HCl diluted with an equal volume of RO water)

The acidified protein solution was reduced in volume from 210 L to 65 L by concentration on a polyethersulfone membrane having a molecular weight cut-off of 100,000 daltons, operated at a temperature of about 51° C. The protein solution, with a protein content of 7.49 wt %, was then diafiltered on the same membrane with 130 L of RO water, with this diafiltration operation conducted at about 55° C.

The 15.50 kg of finer solids captured by the disc stack centrifuge were combined with 60 L of RO water having a temperature of about 60° C. then the mixture was passed through a disc stack centrifuge again to provide 6.83 kg of washed finer solids and 76.9 L of used wash solution.

The diafiltered protein solution was combined with the used wash solution and adjusted to pH 7.17 by the addition of NaOH solution. The combined solution was then concentrated from 3.82 wt % protein to 7.51 wt % protein on the same membrane used to process the acidified protein solution, operated at a temperature of about 49° C. This protein solution was diafiltered on the same membrane with 120 L of RO water, with the diafiltration operation conducted at about 51° C., then further concentrated to a protein content of 9.91 wt %. 32.24 kg of diafiltered and concentrated protein solution was pasteurized at about 72° C. for 16 seconds. 30.76 kg of pasteurized solution was spray dried to yield a product having a protein content of 93.29% (N×6.25) d.b. The product was termed SF19-J31-22A SF871NL.

The coarse residual solids removed by the decanter centrifuge had a protein content of 8.10 wt % and a solids content of 16.78 wt % (48.27% protein (N×6.25) d.b.).

The washed finer solids had a protein content of 8.28 wt % and a solids content of 16.43 wt % (50.40% protein (N×6.25) d.b.).

79.00 kg of coarse residual solids was combined with 5.98 kg of washed finer solids and approximately 145 L of RO water then the mixture spray dried to yield a product having a protein content of 49.35% (N×6.25) d.b. The product was termed SF19-J31-22A SF871PC.

Note all cited pH values were from measurements conducted with the sample at room temperature unless otherwise noted. The extraction slurry was noted as having a pH of 7.11 at 56.5° C.

### Example 27

30 kg of sunflower flour/meal (partially defatted, made from kernels) was combined with 300 L of reverse osmosis purified (RO) water having a temperature of 65° C., 0.30 kg of ascorbic acid and 0.78 kg of 25% NaOH solution. The mixture was stirred for 10 minutes. A portion of the suspended solids (74.77 kg) were removed by centrifugation using a decanter centrifuge to provide a protein solution having a protein content of 3.17 wt % and a pH of 7.51. The protein solution was then further clarified by centrifugation using a disc stack centrifuge to remove additional suspended (finer) solids (24.82 kg) and provide 230 L of protein solution having a protein content of 2.91 wt %. The protein solution was then fed to a three-phase separator which removed 4.26 kg of oil phase and 10.76 kg of suspended solids and provided 234 L of defatted protein solution having a protein content of 2.69 wt % and a pH of 7.43.

The 24.82 kg of finer solids captured by the disc stack centrifuge were combined with 99.28 L of RO water having a temperature of about 60° C. then the mixture was passed through a disc stack centrifuge again to provide 4.26 kg of washed finer solids and 123 L of used wash solution. The used wash solution was then fed to a three-phase separator which removed 0.5 kg of oil phase and 10.84 kg of suspended solids and provided a defatted used wash solution having a protein content of 0.52 wt % and a pH of 7.70.

The defatted protein solution was combined with the defatted used wash solution and the mixture further defatted by filtration through a filter press equipped with 2.0 m pore size filter pads. The filtrate, having a protein content of 1.90 wt % was then adjusted from pH 7.40 to 2.74. The acidified filtrate was then concentrated to 7.33 wt % protein on a polyethersulfone membrane having a molecular weight cut-off of 100,000 daltons, operated at a temperature of about 49° C. The protein solution was then diafiltered on the same membrane with 130 L of RO water, with this diafiltration operation conducted at about 55° C. The diafiltered protein solution was then adjusted to pH 7.36 by the addition of 0.86 kg of 25% NaOH. The pH adjusted protein solution was diafiltered on the same membrane with 140 L of RO water with this diafiltration operation conducted at about 55° C. and further concentrated to a protein content of 8.94 wt %. 44.40 kg of diafiltered and concentrated protein solution was pasteurized at about 72° C. for 16 seconds. 44.0 kg of pasteurized solution was spray dried to yield a product having a protein content of 97.20% (N×6.25) d.b. The product was termed SF19-K23-22A SF871NL.

The coarse residual solids removed by the decanter centrifuge had a protein content of 9.37 wt % and a solids content of 19.68 wt % (47.61% protein (N×6.25) d.b.).

The washed finer solids had a protein content of 6.88 wt % and a solids content of 10.86 wt % (63.35% protein (N×6.25) d.b.).

74.77 kg of coarse residual solids was combined with 4.26 kg of washed finer solids and 149.54 L of RO water then the mixture spray dried to yield a product having a protein content of 47.90% (N×6.25) d.b. The product was termed SF19-K23-22A SF871PC.

Note all cited pH values were from measurements conducted with the sample at room temperature unless otherwise noted. The extraction slurry was noted as having a pH of 7.08 at 61.2° C.

### Example 28

30 kg of sunflower flour/meal (partially defatted, made from kernels) was combined with 300 L of reverse osmosis purified (RO) water having a temperature of 63.9° C., 0.30 kg of ascorbic acid and 0.66 kg of 25% NaOH solution. The mixture was stirred for 10 minutes. A portion of the suspended solids (71.05 kg) were removed by centrifugation using a decanter centrifuge to provide a protein solution having a protein content of 3.27 wt % and a pH of 7.24. The protein solution was then further clarified by centrifugation using a disc stack centrifuge to remove additional suspended (finer) solids (19.56 kg) and provide 240 L of protein solution having a protein content of 3.04 wt %. The protein solution was then fed to a three-phase separator which removed 1.90 kg of oil phase and 10.38 kg of suspended solids and provided 203 L of defatted protein solution having a protein content of 2.91 wt %.

The 19.56 kg of finer solids collected by the disc stack centrifuge were washed by combining them with 78.2 L of RO water having a target temperature of about 60° C. The mixture was run through the disc stack centrifuge again and 8.3 kg of washed finer solids were collected along with 97 L of used wash solution (centrate) having a protein content of 0.71 wt % and a pH of 7.47. The used wash solution was then fed to a three-phase separator which removed 0.26 kg of oil phase and 10.52 kg of suspended solids and provided 89 L of defatted used wash solution having a protein content of 0.68 wt %.

The 203 L of defatted protein solution and 89 L of defatted used wash solution were combined and the pH of the solution adjusted from 7.18 to 3.04 by the addition of 1.94 kg of HCl solution.

The acidified protein solution was reduced in volume from 292 L to 80 L by concentration on a polyethersulfone membrane having a molecular weight cut-off of 100,000 daltons, operated at a temperature of about 52° C. The protein solution, with a protein content of 6.04 wt %, was then diafiltered on the same membrane with 160 L of RO water, with this diafiltration operation conducted at about 41° C. The diafiltered protein solution was then adjusted to pH 7.03 by the addition of 0.70 kg of 25% NaOH. The pH adjusted protein solution was diafiltered on the same membrane with 160 L of RO water with this diafiltration operation conducted at about 53° C. and then further concentrated. This diafiltered and concentrated protein solution was diluted with 5 L water to facilitate drainage from the membrane system. The collected protein solution had a protein content of 8.55 wt % and a pH of 7.25. 38.14 kg of this solution was pasteurized at about 72° C. for 16 seconds. 37.06 kg of pasteurized solution was spray dried to yield a product having a protein content of 98.22% (N×6.25) d.b. The product was termed SF19-K28-22A SF871NL.

The coarse residual solids removed by the decanter centrifuge had a protein content of 10.01 wt % and a solids content of 20.15 wt % (49.68% protein (N×6.25) d.b.).

The washed finer solids had a protein content of 3.68 wt % and a solids content of 5.98 wt % (61.54% protein (N×6.25) d.b.).

Note all cited pH values were from measurements conducted with the sample at room temperature unless otherwise noted. The extraction slurry was noted as having a pH of 7.0 at 59.7° C.

### Example 29

30 kg of sunflower cake/meal (prepared by pressing sunflower kernels) was combined with 300 L of reverse osmosis purified (RO) water having a temperature of 62.1° C., 0.30 kg of ascorbic acid and 0.93 kg of 25% NaOH solution. The mixture was stirred for 50 minutes. A portion of the suspended solids (68.42 kg) were removed by centrifugation using a decanter centrifuge to provide a protein solution having a protein content of 3.52 wt % and a pH of 7.29. The protein solution was then further clarified by centrifugation using a disc stack centrifuge to remove additional suspended (finer) solids (20.12 kg) and provide 227 L of protein solution having a protein content of 3.06 wt %.

The 20.12 kg of finer solids collected by the disc stack centrifuge were washed by combining them with a target volume of 80 L of RO water having a target temperature of about 60° C. The mixture was run through the disc stack centrifuge again and 9.08 kg of washed finer solids were collected along with 81 L of used wash solution (centrate) having a protein content of 0.83 wt % and a pH of 7.65. The 227 L of protein solution and the 81 L of used wash solution were then combined and fed to a three-phase separator which removed 2.52 kg of oil phase and 10.32 kg of suspended solids and provided a defatted protein solution having a protein content of 2.23 wt %.

The pH of the defatted protein solution was adjusted from 7.25 to 2.95 by the addition of 2.3 kg of HCl solution (concentrated HCl diluted with an equal volume of RO water). The acidified protein solution was reduced in volume from 310 L to 80 L by concentration on a polyethersulfone membrane having a molecular weight cut-off of 100,000 daltons, operated at a temperature of about 53° C. The protein solution, with a protein content of 7.78 wt %, was then diafiltered on the same membrane with 160 L of RO water, with this diafiltration operation conducted at about 56° C. The diafiltered protein solution was then adjusted to pH 6.97 by the addition of 0.84 kg of 25% NaOH. The pH adjusted protein solution was diafiltered on the same membrane with 180 L of RO water with this diafiltration operation conducted at about 62° C. and further concentrated to a protein content of 8.53 wt %. This diafiltered and concentrated protein solution had a pH of 7.23. 43.48 kg of diafiltered and concentrated protein solution was pasteurized at about 73° C. for 16 seconds. 42.28 kg of pasteurized solution was spray dried to yield a product having a protein content of 99.06% (N×6.25) d.b. The product was termed SF28-L01-22A SF871NL.

The coarse residual solids removed by the decanter centrifuge had a protein content of 10.55 wt % and a solids content of 20.54 wt % (51.36% protein (N×6.25) d.b.).

The washed finer solids had a protein content of 3.73 wt % and a solids content of 6.38 wt % (58.46% protein (N×6.25) d.b.).

Note all cited pH values were from measurements conducted with the sample at room temperature unless otherwise noted. The extraction slurry was noted as having a pH of 7.12 at 53.1° C.

### Example 30

This Example illustrates the protein content of the sunflower protein products prepared from the sunflower protein solution as described in Examples 1 to 29 as well as the commercially available sunflower protein products Sunbloom (Sunbloom Proteins GmbH), Heliaflor 55 (Austrade Inc.) and Sunflower Seed Powder 50% Protein (Acetar Bio-Tech Inc.).

As-is protein content was determined by combustion analysis (N×6.25). Dry basis protein contents were calculated from the as-is protein value and the dry matter content of the samples. The protein content of the samples is shown in Table 2.

TABLE 2
Protein content of sunflower protein products

| | % protein (N × | % protein (N × |
|---|---|---|
| Product | 6.25), as-is | 6.25), d.b. |
| SF08-B10-22A SF871A | 78.03 | 83.56 |
| SF08-B10-22A SF871N | 75.98 | 81.26 |
| SF11-B14-22A SF871A | 93.96 | not determined |
| SF11-B14-22A SF871N | 87.90 | not determined |
| SF11-B14-22A SF871NL | 92.71 | 98.44 |
| SF11-B16-22A SF871NL | 86.65 | 91.85 |
| SF13-C01-22A SF871N | 80.57 | 85.64 |
| SF11-C02-22A SF871NL | 90.98 | 95.91 |
| SF11-C02-22A SF871NLG | 91.01 | 95.61 |
| SF12-C08-22A SF871NL | 93.17 | 99.37 |
| SF11-C09-22A SF871NL | 87.13 | 91.86 |
| SF14-C24-22A SF871NL | 86.88 | 92.04 |
| SF14-C24-22A SF871NLG | 88.04 | 91.86 |
| SF15-C29-22A SF871N | 75.12 | 78.65 |
| SF15-C30-22A SF871N | 82.07 | 86.61 |
| SF15-D04-22A SF871NL | 95.12 | 100.28 |
| SF16-D05-22A SF871NL | 92.22 | 97.93 |
| SF17-D06-22A SF871NL | 94.64 | 100.90 |
| SF15-D20-22A SF871NL | 98.06 | 103.77 |
| SF17-D26-22A SF871NL | 89.98 | 95.52 |
| SF17-E02-22A SF871NL | 96.83 | 101.86 |
| SF18-E04-22A SF871NL | 97.16 | 103.53 |
| SF19-F01-22A SF871NL-01 | 94.05 | 97.44 |
| SF19-F01-22A SF871NL-02 | 93.89 | 97.27 |
| SF19-F02-22A SF871NL-01 | 92.09 | 96.96 |
| SF19-F02-22A SF871NL-02 | 91.24 | 95.63 |
| SF21-F23-22A SF871NL | 97.98 | 101.86 |
| SF19-F27-22A SF871NL | 90.19 | 94.66 |
| SF25-I07-22A SF871NL | 96.95 | 100.58 |
| SF24-I22-22A SF871NL | 89.89 | 94.13 |
| SF24-I26-22A SF871NL | 90.04 | 93.78 |
| SF19/23-J11-22A SF871NL | 93.76 | 98.18 |
| SF19-J31-22A SF871NL | 89.78 | 93.29 |
| SF19-K23-22A SF871NL | 92.66 | 97.20 |
| SF19-K28-22A SF871NL | 92.75 | 98.22 |
| SF28-L01-22A SF871NL | 94.68 | 99.06 |
| SF19-F01-22A SF871PN | 53.10 | 55.77 |
| SF19-F02-22A SF871PN | 54.38 | 57.86 |
| SF21-F23-22A SF871PN | 50.02 | 52.06 |
| SF19-F27-22A SF871PN | 59.22 | 61.97 |
| SF25-I07-22A SF871PN | 56.35 | not determined |
| SF24-I22-22A SF871PN | 48.94 | 53.24 |
| SF21-F23-22A SF871SM | 48.15 | 50.63 |
| SF24-I26-22A SF871SM | 39.55 | 42.74 |
| SF19/23-J11-22A SF871PC | 44.52 | 47.13 |
| SF19-J31-22A SF871PC | 47.72 | 49.35 |
| SF19-K23-22A SF871PC | 45.05 | 47.90 |
| Sunbloom | 50.48 | 53.97 |
| Heliaflor 55 | 51.43 | 55.06 |
| Sunflower Seed Powder 50% Protein | 56.00 | 58.04 |

As may be seen from the results in Table 2, products derived from the aqueous sunflower protein solution (SF871A or N type products) were much higher in protein than the commercial products evaluated. Products derived from the residual solids were closer in protein content to the commercial products.

### Example 31

This Example illustrates the protein solubility of the sunflower protein products prepared as described in Examples 1-25 and 28-29 as well as the commercially available sunflower protein products Sunbloom (Sunbloom Proteins GmbH) and Sunflower Seed Powder 50% Protein (Acetar Bio-Tech Inc.).

A 100 ml beaker and magnetic stir bar were pre-weighed. Sufficient protein powder to supply 2 g of protein was weighed into the beaker. 10-15 ml of RO water was added and the sample stirred with the stir bar until the powder was thoroughly wetted. At this point another 25-30 ml of RO water was added and mixed in. The pH of the sample was adjusted to the target value with 0.5M NaOH or HCl as necessary and the sample stirred on a magnetic stir plate set to a speed just below forming a vortex in the sample for about 55-60 minutes with the pH periodically checked and adjusted if necessary during this time. After the end of the stirring time the pH of the sample was checked and corrected as necessary again and then additional RO water added to bring the sample weight to 50 g (protein concentration of 4% w/w) and mixed in. Approximately 20 ml of the dispersion was then transferred to a 50 ml centrifuge tube and centrifuged at 10,000 rpm (7,800 g) in a Sorvall SS-34 rotor for 10 minutes with the centrifuge set to 20° C. After the centrifugation was completed 10 ml of supernatant was removed from the centrifuge tube by pipet. Samples of the supernatant and the original dispersion were tested for protein content by combustion analysis (N×6.25).

$$Solubility ( \% ) = ( supernatant protein conc . / original dispersion protein conc . ) \times 100$$

The protein solubility of the sunflower protein products of Examples 1-25 and 28-29 and the commercial products is shown in Table 3.

TABLE 3
Solubility of sunflower protein products at different pH values

| | pH 4 | pH 5.5 | pH 7 |
|---|---|---|---|
| SF08-B10-22A SF871A | 18.8 | 17.6 | 25.0 |
| SF08-B10-22A SF871N | 4.8 | 4.5 | 7.3 |
| SF11-B14-22A SF871NL | 19.3 | 7.9 | 21.0 |
| SF11-B16-22A SF871NL | 8.1 | 9.3 | 22.8 |
| SF13-C01-22A SF871N | 4.8 | 8.5 | 19.8 |
| SF11-C02-22A SF871NL | 17.4 | 7.6 | 26.3 |
| SF11-C02-22A SF871NLG | 21.3 | 8.2 | 21.0 |
| SF12-C08-22A SF871NL | 16.9 | 9.4 | 16.3 |
| SF11-C09-22A SF871NL | 13.5 | 9.7 | 23.4 |
| SF14-C24-22A SF871NL | 17.6 | 8.7 | 21.9 |
| SF14-C24-22A SF871NLG | 17.3 | 16.9 | 36.6 |
| SF15-C29-22A SF871N | 13.9 | 16.0 | 21.6 |
| SF15-C30-22A SF871N | 16.5 | 16.7 | 21.3 |
| SF15-D04-22A SF871NL | 17.0 | 8.6 | 22.7 |
| SF16-D05-22A SF871NL | 17.9 | 9.5 | 27.2 |
| SF17-D06-22A SF871NL | 16.4 | 8.6 | 22.8 |
| SF15-D20-22A SF871NL | 15.9 | 7.4 | 21.0 |
| SF17-D26-22A SF871NL | 15.1 | 9.7 | 14.9 |
| SF17-E02-22A SF871NL | 17.4 | 12.0 | 19.2 |
| SF18-E04-22A SF871NL | 9.1 | 3.5 | 11.8 |
| SF19-F01-22A SF871NL-01 | 25.7 | 12.4 | 28.0 |
| SF19-F02-22A SF871NL-01 | 21.4 | 10.5 | 25.3 |
| SF19-F02-22A SF871NL-02 | 19.7 | 9.6 | 25.1 |
| SF21-F23-22A SF871NL | 24.3 | 14.0 | 28.9 |
| SF19-F27-22A SF871NL | 17.0 | 7.1 | 19.4 |
| SF25-I07-22A SF871NL | 16.0 | 8.8 | 17.1 |
| SF24-I22-22A SF871NL | 15.8 | 8.1 | 21.2 |
| SF24-I26-22A SF871NL | 15.8 | 8.2 | 18.7 |
| SF19/23-J11-22A SF871NL | 15.0 | 8.8 | 20.2 |
| SF19-K28-22A SF871NL | 20.4 | 10.9 | 22.6 |
| SF28-L01-22A SF871NL | 17.0 | 9.0 | 16.9 |
| SF19-F01-22A SF871PN | 13.6 | 9.3 | 14.3 |
| SF19-F02-22A SF871PN | 13.1 | 7.0 | 14.9 |
| SF21-F23-22A SF871PN | 15.1 | 7.8 | 9.6 |
| SF19-F27-22A SF871PN | 10.9 | 5.8 | 8.7 |
| SF19/23-J11-22A SF871PC | 22.4 | 14.2 | 17.0 |
| Sunbloom | 20.4 | 20.7 | 41.4 |
| Sunflower Seed Powder 50% Protein | 15.7 | 12.5 | 13.1 |

As may be seen from the results presented in Table 3, the solubility of the 871 protein products evaluated was generally within or below the range of the commercial products.

### Example 32

This Example contains an evaluation of the dry colour of the sunflower protein products prepared as described in Example 1 to 29 as well as the commercially available sunflower protein products Sunbloom (Sunbloom Proteins GmbH) and Heliaflor 55 (Austrade Inc.). Dry colour (CIEL*a*b*) was assessed using either a HunterLab ColorQuest XE or HunterLab UltraScan VIS instrument operated in reflectance mode (RSEX) with an illuminant setting of D65 and an observer setting of 100. The results are shown in the following Table 4.

TABLE 4
Dry colour of sunflower protein products

| Product | L* | a* | b* |
|---|---|---|---|
| SF08-B10-22A SF871A | 54.58 | 3.83 | 19.66 |
| SF08-B10-22A SF871N | 52.54 | 4.28 | 20.40 |
| SF11-B14-22A SF871NL | 80.69 | 0.31 | 14.50 |
| SF11-B16-22A SF871NL | 79.14 | 0.45 | 13.72 |
| SF13-C01-22A SF871N | 57.41 | 4.31 | 21.90 |
| SF11-C02-22A SF871NL | 78.47 | 0.86 | 14.49 |
| SF11-C02-22A SF871NLG | 79.40 | 0.74 | 13.97 |
| SF12-C08-22A SF871NL | 81.34 | 0.50 | 11.79 |
| SF11-C09-22A SF871NL | 79.97 | 0.39 | 14.31 |
| SF14-C24-22A SF871NL | 82.07 | 0.09 | 11.60 |
| SF14-C24-22A SF871NLG | 82.93 | −0.01 | 11.27 |
| SF15-C29-22A SF871N | 73.72 | 1.33 | 15.77 |
| SF15-C30-22A SF871N | 77.85 | 0.83 | 16.37 |
| SF15-D04-22A SF871NL | 82.34 | −0.11 | 13.99 |
| SF16-D05-22A SF871NL | 68.01 | 2.37 | 18.16 |
| SF17-D06-22A SF871NL | 82.06 | −0.24 | 13.66 |
| SF15-D20-22A SF871NL | 83.40 | −0.04 | 13.11 |
| SF17-D26-22A SF871NL | 74.69 | 1.28 | 15.72 |
| SF17-E02-22A SF871NL | 82.89 | −0.12 | 13.31 |
| SF18-E04-22A SF871NL | 82.66 | 0.07 | 11.91 |
| SF19-F01-22A SF871NL-01 | 81.77 | −0.08 | 14.85 |
| SF19-F01-22A SF871NL-02 | 82.84 | −0.21 | 13.86 |
| SF19-F02-22A SF871NL-01 | 57.36 | −1.96 | 14.67 |
| SF19-F02-22A SF871NL-02 | 60.70 | −1.99 | 13.85 |
| SF21-F23-22A SF871NL | 84.11 | −0.49 | 12.24 |
| SF19-F27-22A SF871NL | 79.00 | 0.24 | 16.40 |
| SF25-I07-22A SF871NL | 82.36 | 0.22 | 12.99 |
| SF24-I22-22A SF871NL | 83.87 | 0.49 | 14.53 |
| SF24-I26-22A SF871NL | 84.18 | 0.27 | 13.92 |
| SF19/23-J11-22A SF871NL | 74.34 | 1.19 | 16.85 |
| SF19-J31-22A SF871NL | 80.28 | 0.72 | 13.55 |
| SF19-K23-22A SF871NL | 81.09 | −1.05 | 17.24 |
| SF19-K28-22A SF871NL | 83.14 | −0.04 | 12.72 |
| SF28-L01-22A SF871NL | 83.18 | −0.11 | 12.36 |
| SF19-F01-22A SF871PN | 76.06 | 0.05 | 14.33 |
| SF19-F02-22A SF871PN | 66.78 | −0.15 | 15.48 |
| SF21-F23-22A SF871PN | 79.02 | −0.58 | 13.01 |
| SF19-F27-22A SF871PN | 75.92 | −0.08 | 14.98 |
| SF24-I22-22A SF871PN | 80.08 | 0.82 | 14.70 |
| SF21-F23-22A SF871SM | 77.02 | 0.47 | 14.23 |
| SF24-I26-22A SF871SM | 79.72 | 1.22 | 16.03 |
| SF19/23-J11-22A SF871PC | 80.79 | 0.53 | 12.85 |
| SF19-J31-22A SF871PC | 76.40 | 0.57 | 15.38 |
| SF19-K23-22A SF871PC | 77.70 | 0.74 | 14.08 |
| Sunbloom | 79.89 | 0.19 | 9.15 |
| Heliaflor 55 | 78.96 | −0.20 | 9.78 |

As may be seen from the results of Table 4, products of the invention derived from the aqueous sunflower solution, with kernel as the sunflower protein source, had a colour that was lighter, greener and bluer than product derived from the aqueous sunflower solution with black oil seed meal containing hull material as the sunflower protein source. Products of the invention derived from the aqueous sunflower solution, with kernel as the sunflower protein source, were darker and greener when ascorbic acid was not included in the extraction. The colour of products of the invention prepared from kernel was slightly yellower than the commercial products evaluated.

### Example 33

This Example contains an evaluation of the water binding capacity of the sunflower protein products prepared as described in Examples 1 to 11, 13-18, 20-27 and 29 as well as the commercially available sunflower protein products Sunbloom (Sunbloom Proteins GmbH), Sunflower Seed Powder 50% Protein (Acetar Bio-Tech Inc.) and Heliaflor 55 (Austrade Inc.).

The water binding capacity of the products was determined by the following procedure. Protein powder (1 g) was weighed into centrifuge tubes (50 ml) of known weight. To this powder was added approximately 20 ml of RO water at the natural pH. The contents of the tubes were mixed using a vortex mixer at moderate speed for 1 minute. The samples were incubated at room temperature for 5 minutes then mixed with the vortex for 30 seconds. This was followed by incubation at room temperature for another 5 minutes then another 30 seconds of vortex mixing. The samples were then centrifuged at 1,000 g for 15 minutes at 20° C. After centrifugation, the supernatant was carefully poured off, ensuring that all solid material remained in the tube. The centrifuge tube was then re-weighed and the weight of water saturated sample was determined.

### Water Binding Capacity (WBC) was Calculated as:

$$WBC ( ml / g ) = ( mass of water saturated sample ( g ) - mass of initial sample ( g ) ) \text{} / ( mass of initial sample ( g ) \times total solids content of sample )$$

The WBC results are shown in Table 5.

TABLE 5
WBC of sunflower protein products

| Product | WBC (ml/g) |
|---|---|
| SF08-B10-22A SF871N | 2.22 |
| SF11-B14-22A SF871NL | 3.17 |
| SF11-B16-22A SF871NL | 3.36 |
| SF13-C01-22A SF871N | 2.56 |
| SF11-C02-22A SF871NL | 2.38 |
| SF12-C08-22A SF871NL | 3.22 |
| SF11-C09-22A SF871NL | 2.63 |
| SF14-C24-22A SF871NL | 2.80 |
| SF14-C24-22A SF871NLG | 1.91 |
| SF15-C29-22A SF871N | 2.27 |
| SF15-C30-22A SF871N | 2.56 |
| SF15-D04-22A SF871NL | 2.76 |
| SF17-D06-22A SF871NL | 2.69 |
| SF15-D20-22A SF871NL | 3.20 |
| SF17-D26-22A SF871NL | 2.92 |
| SF17-E02-22A SF871NL | 2.92 |
| SF18-E04-22A SF871NL | 3.52 |
| SF19-F01-22A SF871NL-01 | 3.11 |
| SF21-F23-22A SF871NL | 2.48 |
| SF19-F27-22A SF871NL | 3.06 |
| SF25-I07-22A SF871NL | 3.14 |
| SF24-I22-22A SF871NL | 2.75 |
| SF24-I26-22A SF871NL | 2.73 |
| SF28-L01-22A SF871NL | 3.12 |
| SF19-F01-22A SF871PN | 2.08 |
| SF21-F23-22A SF871PN | 2.29 |
| SF19-F27-22A SF871PN | 2.38 |
| SF21-F23-22A SF871SM | 5.69 |
| SF24-I26-22A SF871SM | 8.24 |
| SF19/23-J11-22A SF871PC | 5.69 |
| SF19-J31-22A SF871PC | 5.25 |
| SF19-K23-22A SF871PC | 5.38 |
| Sunbloom | 3.10 |
| Sunflower Seed Powder 50% Protein | 1.75 |
| Heliaflor 55 | 3.68 |

As may be seen from the results in Table 5, products of the invention derived from the aqueous sunflower protein solution had water binding capacity within the range of the commercial products. Products of the invention derived from the coarse residual solids had higher water binding capacity than the commercial products evaluated.

### Example 34

This Example contains an evaluation of the oil binding capacity of the sunflower protein product prepared as described in Example 1-11, 13-18, 20-27 and 29 as well as the commercially available sunflower protein products Sunbloom (Sunbloom Proteins GmbH), Sunflower Seed Powder 50% Protein (Acetar Bio-Tech Inc.) and Heliaflor 55 (Austrade Inc.).

The oil binding capacity of the products was determined by the following procedure. Protein powder (1 g) was weighed into centrifuge tubes (50 ml) of known weight. To this powder was added approximately 20 ml of retail canola oil. The contents of the tubes were mixed using a vortex mixer at moderate speed for 1 minute. The samples were incubated at room temperature for 5 minutes then mixed with the vortex for 30 seconds. This was followed by incubation at room temperature for another 5 minutes then another 30 seconds of vortex mixing. The samples were then centrifuged at 1,000 g for 15 minutes at 20° C. After centrifugation, the supernatant was pipetted off, ensuring that all solid material remained in the tube. The centrifuge tube was then re-weighed and the weight of oil saturated sample was determined.

### Oil Binding Capacity (OBC) was Calculated as:

$$OBC ( ml / g ) = ( ( mass of oil saturated sample ( g ) - mass of initial sample ( g ) ) \text{} / \text{} 0.914 \text{} g \text{} / \text{} ml ) / ( mass of initial sample ( g ) \times total solids content of sample ) .$$

The OBC results are shown in Table 6.

TABLE 6
OBC of sunflower protein products

| Product | OBC (ml/g) |
|---|---|
| SF08-B10-22A SF871N | 1.36 |
| SF11-B14-22A SF871NL | 1.84 |
| SF11-B16-22A SF871NL | 0.97 |
| SF13-C01-22A SF871N | 1.16 |
| SF11-C02-22A SF871NL | 0.93 |
| SF12-C08-22A SF871NL | 1.03 |
| SF11-C09-22A SF871NL | 1.73 |
| SF14-C24-22A SF871NL | 0.99 |
| SF14-C24-22A SF871NLG | 1.57 |
| SF15-C29-22A SF871N | 1.14 |
| SF15-C30-22A SF871N | 1.08 |
| SF15-D04-22A SF871NL | 1.55 |
| SF17-D06-22A SF871NL | 1.23 |
| SF15-D20-22A SF871NL | 1.15 |
| SF17-D26-22A SF871NL | 1.07 |
| SF17-E02-22A SF871NL | 1.15 |
| SF18-E04-22A SF871NL | 1.03 |
| SF19-F01-22A SF871NL-01 | 1.45 |
| SF21-F23-22A SF871NL | 1.25 |
| SF19-F27-22A SF871NL | 1.61 |
| SF25-I07-22A SF871NL | 1.11 |
| SF24-I22-22A SF871NL | 0.86 |
| SF24-I26-22A SF871NL | 0.91 |
| SF28-L01-22A SF871NL | 0.89 |
| SF19-F01-22A SF871PN | 1.52 |
| SF21-F23-22A SF871PN | 1.22 |
| SF19-F27-22A SF871PN | 0.86 |
| SF21-F23-22A SF871SM | 2.21 |
| SF24-I26-22A SF871SM | 2.38 |
| SF19/23-J11-22A SF871PC | 2.69 |
| SF19-J31-22A SF871PC | 2.20 |
| SF19-K23-22A SF871PC | 2.17 |
| Sunbloom | 1.79 |
| Sunflower Seed Powder 50% Protein | 0.96 |
| Heliaflor 55 | 1.35 |

As may be seen from the results in Table 6, products of the invention derived from the aqueous sunflower protein solution had oil binding capacity generally in the same range as the commercial products. Products of the invention derived from the coarse residual solids had higher oil binding capacity than the commercial products evaluated.

### Example 35

This Example contains an evaluation of the phytic acid content of the sunflower protein products prepared as described in Examples 1-4 and 25-29 as well as the commercially available sunflower protein products Sunbloom (Sunbloom Proteins GmbH), Sunflower Seed Powder 50% Protein (Acetar Bio-Tech Inc.) and Heliaflor 55 (Austrade Inc.). Phytic acid content was determined using the method of Latta and Eskin (J. Agric. Food Chem., 28: 1313-1315) and expressed on a dry basis.

The phytic acid content of the protein products prepared as described in Examples 1-4 and 25-29 is shown in Table 7.

TABLE 7
Phytic acid content of sunflower protein products

| Product | % phytic acid d.b. |
|---|---|
| SF08-B10-22A SF871A | 0.97 |
| SF08-B10-22A SF871N | 0.92 |
| SF11-B14-22A SF871NL | 1.14 |
| SF11-B16-22A SF871NL | 2.74 |
| SF13-C01-22A SF871N | 1.67 |
| SF19-J31-22A SF871NL | 1.00 |
| SF19-K23-22A SF871NL | 0.87 |
| SF19-K28-22A SF871NL | 1.22 |
| SF28-L01-22A SF871NL | 1.13 |
| SF19/23-J11-22A SF871PC | 6.16 |
| SF19-J31-22A SF871PC | 7.03 |
| SF19-K23-22A SF871PC | 6.82 |
| Sunbloom | 5.60 |
| Sunflower Seed Powder 50% Protein | 3.51 |
| Heliaflor 55 | 5.75 |

As may be seen from the results in Table 7, the phytic acid results were lower for the products of Examples 1-2 and 25-29 (finer solids removed by the disc stack centrifuge and 3-phase separator) compared to the product of Example 4 where the disc stack centrifuge was not employed or Example 3 where the disc stack centrifuge was not employed and the solids collected by the 3-phase separator were added back to the protein solution. Products derived from the coarse and finer residual solids were higher in phytic acid than the products prepared from the aqueous sunflower protein solution.

### Example 36

This Example describes the amino acid profile of the sunflower protein products prepared as described in Examples 2, 3, 6, 18, 22-25 and 28.

Amino acid profiles of the sunflower protein products were assessed experimentally according to method reference USDA MSS2 (1993) by Merieux NutriSciences (Crete, IL). A complete amino acid profile was done, to quantify tryptophan, cysteine/methionine and the remaining amino acids.

Amino acid profiles for sunflower protein products prepared as described in Examples 2, 3, 6, 18, 22-25 and 28 are shown in Tables 8 and 9 below.

TABLE 8
Amino acid profile of sunflower protein products

| | concentration (mg/g protein) | | | | | | |
|---|---|---|---|---|---|---|---|
| | SF11- | SF11- | SF12- | SF19-F01- | SF25- | SF24- | SF19- |
| | B14-22A | B16-22A | C08-22A | 22A | I07-22A | I22-22A | K28-22A |
| amino acid | SF871NL | SF871NL | SF871NL | SF871NL-01 | SF871NL | SF871NL | SF871NL |
| Aspartic | 116.6 | 110.2 | 110.1 | 87.2 | 92.0 | 96.3 | 94.2 |
| Threonine | 44.3 | 44.2 | 41.6 | 31.4 | 31.5 | 35.4 | 32.4 |
| Serine | 54.2 | 52.3 | 51.2 | 38.3 | 39.0 | 41.2 | 40.5 |
| Glutamic | 138.2 | 125.3 | 129.6 | 125.5 | 131.3 | 126.1 | 188.8 |
| Proline | 63.1 | 59.8 | 60.2 | 58.4 | 56.5 | 56.7 | 58.8 |
| Glycine | 58.2 | 57.3 | 54.1 | 44.1 | 44.1 | 46.1 | 46.0 |
| Alanine | 51.4 | 50.9 | 48.9 | 37.6 | 37.6 | 41.4 | 36.2 |
| Valine | 54.2 | 54.8 | 52.8 | 43.9 | 43.3 | 46.0 | 45.0 |
| Isoleucine | 48.2 | 47.3 | 46.6 | 38.1 | 36.6 | 38.0 | 39.6 |
| Leucine | 75.5 | 75.1 | 73.1 | 54.5 | 54.6 | 58.4 | 57.8 |
| Tyrosine | 36.2 | 35.7 | 35.0 | 26.2 | 25.7 | 27.7 | 27.7 |
| Phenylalanine | 61.6 | 59.3 | 60.0 | 46.1 | 45.8 | 48.8 | 49.8 |
| Lysine | 38.0 | 37.9 | 34.9 | 27.4 | 27.2 | 30.0 | 28.1 |
| Histidine | 33.3 | 31.7 | 31.3 | 24.6 | 23.8 | 25.3 | 25.8 |
| Arginine | 116.6 | 108.8 | 106.6 | 88.7 | 90.0 | 89.5 | 89.8 |
| Cysteine | 23.4 | 22.6 | 23.3 | 17.5 | 15.2 | 14.2 | 16.6 |
| Methionine | 33.1 | 29.6 | 30.2 | 24.7 | 22.9 | 23.4 | 24.6 |
| Tryptophan | 11.0 | 11.7 | 11.8 | 10.6 | 11.8 | 12.2 | 11.2 |

TABLE 9
Amino acid profile of sunflower protein
products from residual solids

| | concentration (mg/g protein) | | |
|---|---|---|---|
| | SF19-F01-22A | SF24-I26-22A | SF19/23-J11-22A |
| amino acid | SF871PN | SF871SM | SF871PC |
| Aspartic | 84.5 | 80.7 | 78.8 |
| Threonine | 37.2 | 38.9 | 36.8 |
| Serine | 41.5 | 46.1 | 44.7 |
| Glutamic | 122.8 | 124.1 | 85.6 |
| Proline | 57.1 | 56.0 | 56.6 |
| Glycine | 50.2 | 70.5 | 65.8 |
| Alanine | 42.8 | 41.8 | 41.8 |
| Valine | 48.7 | 46.6 | 45.8 |
| Isoleucine | 40.4 | 37.0 | 38.0 |
| Leucine | 62.7 | 60.3 | 61.8 |
| Tyrosine | 27.9 | 23.9 | 23.4 |
| Phenylalanine | 46.1 | 39.9 | 39.3 |
| Lysine | 36.2 | 41.0 | 38.6 |
| Histidine | 24.8 | 23.6 | 23.6 |
| Arginine | 81.1 | 75.0 | 75.7 |
| Cysteine | 15.7 | 19.6 | 20.7 |
| Methionine | 20.3 | 16.6 | 16.6 |
| Tryptophan | 12.1 | 11.8 | 10.6 |

As may be seen from the results in Tables 8 and 9, products of the invention had a high content of sulfur containing amino acids, isoleucine and valine.

### Example 37

This Example illustrates the chlorogenic acid content of the sunflower protein products prepared by the procedures of Examples 2, 22-28 and the commercial product Heliaflor 55 (Austrade Inc.). The chlorogenic acid content was determined by modified AOAC 2018.08 by Vanguard Laboratory (Olympia, WA). The results are shown in Table 10.

TABLE 10
Chlorogenic acid content of sunflower protein products

| Product | Chlorogenic acid content (ppm d.b.) |
|---|---|
| SF11-B14-22A SF871NL | 218 |
| SF25-I07-22A SF871NL | 137 |
| SF24-I22-22A SF871NL | 120 |
| SF24-I26-22A SF871NL | 56 |
| SF19/23-J11-22A SF871NL | 93 |
| SF19-J31-22A SF871NL | 110 |
| SF19-K23-22A SF871NL | 86 |
| SF19-K28-22A SF871NL | 226 |
| SF24-I22-22A SF871PN | 1055 |
| SF24-I26-22A SF871SM | 7976 |
| SF19/23-J11-22A SF871PC | 4778 |
| SF19-J31-22A SF871PC | 6366 |
| SF19-K23-22A SF871PC | 3755 |
| Heliaflor 55 | 21,684 |

As may be seen from the results in Table 10, the products were much lower in chlorogenic acid than the Heliaflor 55, particularly the products derived from the aqueous protein solution.

### Example 38

This Example illustrates the sodium content of products prepared as described in Examples 9-11, 12, 21, 23, 25-26 and 28.

Sodium contents were determined by AOAC 984.27 by Merieux NutriSciences (Markham, ON). Moisture contents were determined by AOAC 950.46 by Merieux NutriSciences (Markham, ON) and the sodium contents expressed on dry basis.

The results are as shown in Table 11.

TABLE 11
Sodium content of sunflower protein products

| Product | Sodium (%) d.b. |
|---|---|
| SF15-C29-22A SF871N | 2.71 |
| SF15-C30-22A SF871N | 2.35 |
| SF15-D04-22A SF871NL | 0.99 |
| SF17-D06-22A SF871NL | 0.90 |
| SF19-F27-22A SF871NL | 1.04 |
| SF24-I22-22A SF871NL | 0.62 |
| SF19-K28-22A SF871NL | 0.71 |
| SF24-I22-22A SF871PN | 0.22 |
| SF19/23-J11-22A SF871PC | 0.28 |
| SF19-J31-22A SF871PC | 0.27 |

As may be seen from the results in Table 11, for products derived from the aqueous sunflower protein solution, membrane processing after pH adjustment lowered the sodium content. The product derived from residual solids was lower in sodium than the product derived from the aqueous sunflower protein solution.

### Example 39

This Example illustrates the fat content of the products prepared as described in Examples 1-13, 17-18 and 20-29. The fat content was determined using an acid hydrolysis method (AOAC 933.05) by Merieux NutriSciences (Markham, ON). Moisture contents were determined by AOAC 950.46 by Merieux NutriSciences (Markham, ON) and the acid hydrolysis fat contents expressed on dry basis. The results are shown in Table 12.

TABLE 12
Acid hydrolysis fat content of sunflower protein products

| Product | Acid hydrolysis fat content (% d.b.) |
|---|---|
| SF08-B10-22A SF871N | 11.17 |
| SF11-B14-22A SF871NL | 5.72 |
| SF11-B16-22A SF871NL | 7.68 |
| SF13-C01-22A SF871N | 4.60 |
| SF11-C02-22A SF871NL | 7.78 |
| SF12-C08-22A SF871NL | 5.50 |
| SF11-C09-22A SF871NL | 9.18 |
| SF14-C24-22A SF871NL | 10.86 |
| SF15-C29-22A SF871N | 5.83 |
| SF15-C30-22A SF871N | 5.90 |
| SF15-D04-22A SF871NL | 2.30 |
| SF16-D05-22A SF871NL | 2.60 |
| SF17-D06-22A SF871NL | 2.56 |
| SF18-E04-22A SF871NL | 2.89 |
| SF19-F01-22A SF871NL-01 | 4.60 |
| SF21-F23-22A SF871NL | 1.54 |
| SF19-F27-22A SF871NL | 4.21 |
| SF25-I07-22A SF871NL | 1.82 |
| SF24-I22-22A SF871NL | 8.81 |
| SF24-I26-22A SF871NL | 9.01 |
| SF19/23-J11-22A SF871NL | 5.10 |
| SF19-J31-22A SF871NL | 10.12 |
| SF19-K23-22A SF871NL | 5.42 |
| SF19-K28-22A SF871NL | 5.27 |
| SF28-L01-22A SF871NL | 5.78 |
| SF19-F01-22A SF871PN | 9.39 |
| SF21-F23-22A SF871PN | 16.71 |
| SF19-F27-22A SF871PN | 8.27 |
| SF24-I22-22A SF871PN | 5.65 |
| SF21-F23-22A SF871SM | 11.60 |
| SF24-I26-22A SF871SM | 13.44 |
| SF19/23-J11-22A SF871PC | 9.96 |
| SF19-J31-22A SF871PC | 10.85 |
| SF19-K23-22A SF871PC | 10.29 |

As may be seen from the results in Table 12, products derived from the aqueous sunflower protein solution were generally lower in fat than the products derived from the residual solids.

### Example 40

This Example illustrates the viscosity in solution of the sunflower protein products prepared as described in Examples 2, 3, 5 and 11. Solutions of the products were prepared at 10% protein and the viscosity of the solutions determined at different shear rates using an Anton Paar MCR 302 rheometer fitted with a PP25 plate/plate system. The protein solution sample was placed on the bottom plate and the upper plate was lowered to a 1 mm gap. The viscosity was tested at 25° C. with increasing shear rate from 0.1 to 100 l/s.

Results are as shown in Table 13.

TABLE 13
Viscosity of sunflower protein solutions at different shear rates

| | Viscosity (mPa · s) | | | | |
|---|---|---|---|---|---|
| Shear | SF11- | SF11- | SF11- | SF11- | SF15- |
| rate | B14-22A | B16-22A | C02-22A | C02-22A | D04-22A |
| (1/s) | SF871NL | SF871NL | SF871NL | SF871NLG | SF871NL |
| 1.28 | 19.3 | 25.7 | 21.7 | 545.0 | 28.8 |
| 1.84 | 18.6 | 25.0 | 21.8 | 422.2 | 27.7 |
| 2.64 | 18.0 | 24.8 | 21.7 | 336.2 | 26.0 |
| 3.79 | 18.8 | 23.5 | 21.8 | 270.2 | 24.9 |
| 5.46 | 18.6 | 23.4 | 21.5 | 222.2 | 24.2 |
| 7.86 | 17.4 | 22.9 | 21.7 | 184.9 | 23.5 |
| 11.30 | 16.2 | 22.4 | 21.5 | 159.2 | 22.9 |
| 16.30 | 16.3 | 22.3 | 21.6 | 137.0 | 22.5 |
| 23.40 | 16.3 | 22.2 | 21.5 | 117.5 | 22.0 |
| 33.60 | 17.0 | 22.1 | 21.4 | 103.1 | 21.4 |
| 48.40 | 16.9 | 21.8 | 21.4 | 90.0 | 21.0 |
| 69.60 | 16.5 | 21.3 | 20.8 | 79.6 | 20.0 |
| 100.00 | 15.7 | 20.7 | 20.3 | 70.5 | 19.4 |

As may be seen from the results presented in Table 13, the jet cooking in Example 5 increased the viscosity of the product derived from the aqueous sunflower protein solution.

### Example 41

This Example illustrates the preparation of a dairy alternative beverage with a protein content of 3.5 wt %, using the sunflower protein product prepared by the procedure of Example 2. The formulation for the sunflower protein dairy alternative beverage was as shown in Table 14.

TABLE 14
Formulation for dairy alternative beverage

| Ingredient | Amount (g) | Percentage (%) |
|---|---|---|
| Water, spring | 363.70 | 90.92 |
| SF11-B14-22A-SF871NL | 15.10 | 3.78 |
| Sugar, white | 12.00 | 3.00 |
| Canola oil | 8.00 | 2.00 |
| Flavour, dry, vanilla | 0.80 | 0.20 |
| Stabilizer, gellan gum | 0.40 | 0.10 |
| Total | 400.0 | 100.00 |

The protein powder, sugar, and stabilizer were placed in a large beaker. The water was added to the dry ingredients and mixed on a magnetic stirring hot plate. When the mixture was dispersed, the oil was slowly added while continually mixing. To batch pasteurize, the product was heated on the magnetic stirring hot plate. When the product reached a temperature between 65° C. and 70° C., the flavour was added. The product was pasteurized at 72-76° C. for 30 seconds. After pasteurization, the product was homogenized using a GEA Niro Soavi Panda Plus at 175 bar/35 bar (210 total). The product was filled into a bottle and stored at refrigerated temperature (4° C.).

The beverage was tasted by a sensory panel with twelve participants. Comments provided by the panelists confirmed that an edible beverage of at least acceptable quality was prepared with the product of the present disclosure. Specific comments included “good colour”, “creamy appearance”, “smooth mouthfeel”, “milky smooth”, “smooth texture”, “sweet”, “clean”, “creamy”, and “good sweetness and flavour.”

What has been described is merely illustrative of the application of the principles of the disclosure. However, it will be apparent to a person skilled in the art that a number of variations and modifications can be made without departing from the scope of the following claims. Such variations and modifications are intended to be captured by the invention and/or following claims. All examples, embodiments, aspects, methods and products disclosed herein are illustrative and are not intended to be limiting in any way.

1. A process for preparing a sunflower protein product from a sunflower protein source, the sunflower protein product having a protein content of greater than 60 wt % (N×6.25) d.b, the process comprising:
a) extracting sunflower protein from a sunflower protein source, optionally with water, to cause solubilization of the sunflower protein from the sunflower protein source to produce an aqueous phase and a residual sunflower protein source;
b) separating the aqueous phase from the residual sunflower protein source to produce an aqueous sunflower protein solution and a separated residual sunflower protein source
c) optionally defatting the separated aqueous sunflower protein solution to at least partially remove fat from the separated aqueous sunflower protein solution;
d) adjusting the pH of the aqueous sunflower protein solution to an acidic value in the range of about pH 1.5 to about pH 5.0 to provide an acidified aqueous sunflower protein solution;
e) optionally concentrating the acidified aqueous sunflower protein solution to provide a concentrated sunflower protein solution having a protein concentration of about 5 to about 30 wt %;
f) optionally diafiltering the concentrated acidified sunflower protein solution using water as the diafiltration solution or diafiltering the acidified aqueous sunflower protein solution using water prior to concentration or diafiltering the partially concentrated acidified aqueous sunflower protein solution using water;
g) optionally drying the acidified aqueous sunflower protein solution (d) or optionally concentrated and/or diafiltered sunflower protein solution ((e) or (f)) to provide a sunflower protein product;
wherein the aqueous sunflower protein solution obtained in step b) is optionally treated with an anti-foamer, such as any suitable food-grade, non-silicone based anti-foamer, to reduce the volume of foam formed upon further processing, and wherein the anti-foamer is optionally added during the extraction step a) optionally in a quantity greater than about 0.0003% w/v;
wherein the aqueous sunflower protein solution obtained in step b) is optionally treated with an adsorbent, such as granulated activated carbon, to remove colour and/or odour compounds;
wherein steps e) and f) may optionally be carried out simultaneously.

2. (canceled)

3. (canceled)

4. (canceled)

5. The process of claim 1, wherein:
the separation step b) comprises centrifugation and/or filtration optionally with a decanter centrifuge and a disc stack centrifuge; and/or
the separation step b) is conducted at the same temperature as the extraction step or at any temperature within the range of about 1° C. to about 100° C., preferably about 15° C. to about 65° C., more preferably about 50° C. to about 60° C.; and/or
the separated residual sunflower protein source obtained in step b) is further processed, such as to recover residual protein; and/or
the separated residual protein source obtained in step b) is re-extracted with fresh water to recover residual protein and the re-extraction protein solution is separated from the residual sunflower protein source and optionally combined with the aqueous sunflower protein solution for further processing.

6. The process of claim 1, wherein defatting of the separated aqueous sunflower protein solution is achieved by centrifugation and/or filtration, optionally wherein:
defatting comprises the use of a three-phase centrifuge, such as a three-phase separator, for the simultaneous separation of fat and residual solids from the protein solution; and/or
the residual solids captured by the three phase centrifuge are optionally added back to the protein solution for further processing.

7. (canceled)

8. (canceled)

9. The process of claim 1, wherein in step a):
solubilization from the sunflower protein source is effected using water having different levels of purity such as tap water or reverse osmosis (RO) purified water and/or
a pH of the extraction may be the natural pH of the combination of the water and the sunflower protein source, or the pH of the extraction may be adjusted us to any value between the natural pH and about 8.5, or the pH may be adjusted within the range of about 6.8 to about 8.0, or the pH may be adjusted to about 6.8 to about 7.5; and/or
a food grade sodium hydroxide, potassium hydroxide or any other conventional food grade alkali and combinations thereof are added to the water to adjust the PH of the extraction; and/or
solubilization of the protein is effected at a temperature of from about 1° C. to about 100° C., preferably about 15° C. to about 65° C., more preferably about 50° C. to about 60° C., preferably accompanied by agitation; and/or
the solubilization time is about 1 to about 60 minutes, preferably about 10 to about 30 minutes; and/or
the concentration of the sunflower protein source in the water during the extraction step is about 5 to about 20% w/v, preferably about 5 to about 15% w/v; and/or
the aqueous phase resulting from the extraction step generally has a protein concentration of about 0.5 to about 5 wt %, preferably about 1 to about 5 wt %; and/or
the water of extraction may contain an antioxidant, such as ascorbic acid optionally in an amount of from about 0.01 to about 1 wt % of the solution, preferably about 0.05 to about 0.15 wt %, more preferably about 0.05 to about 0.10 wt %; and/or
the extraction is carried out using a counter-current extraction procedure; and/or
the extraction is carried out in a continuous operation or a batch operation.

10. (canceled)

11. (canceled)

12. (canceled)

13. (canceled)

14. (canceled)

15. (canceled)

16. (canceled)

17. (canceled)

18. The process of claim 1, wherein in step d):
the separated sunflower protein solution is adjusted to a pH of about 1.5 to about 4.0 or about 2.0 to about 3.0; and/or
the separated sunflower protein solution is adjusted in pH by the addition of any food grade acid such as hydrochloric acid, phosphoric acid, or citric acid.

19. (canceled)

20. The process of claim 1, wherein said acidified aqueous sunflower protein solution is subjected to a heat treatment step to at least partially inactivate heat-labile anti-nutritional factors, optionally wherein:
the anti-nutritional factors are heat-labile trypsin inhibitors; and/or
the heat treatment step is effected to pasteurize the acidified aqueous protein solution; and/or
said heat treatment is effected at a temperature, and for a time, selected from the group consisting of about 70° C. to about 160° C. for about 10 seconds to about 60 minutes, about 80° C. to about 120° C. for about 10 seconds to about 5 minutes and about 85° C. to about 95° C. for about 30 seconds to about 5 minutes; and/or
the heat treated acidified sunflower protein solution is cooled to a temperature selected from the group consisting of about 2° C. to about 65° C. and about 50° C. to about 60° C.

21. (canceled)

22. (canceled)

23. (canceled)

24. (canceled)

25. (canceled)

26. The process of claim 1, wherein in step e):
the protein concentration is about 5 to about 20 wt %, preferably about 10 to about 20 wt %; and/or
the concentration step is effected by selective membrane technique, such as ultrafiltration or diafiltration, using membranes, such as hollow-fibre membranes or spiral-wound membranes, with a suitable molecular weight cut-off, such as about 1,000 to about 1,000,000 daltons, preferably about 1,000 to about 100,000 daltons, more preferably about 10,000 to about 100,000 daltons; and/or
the concentration step effected in such a manner that the sunflower protein product subsequently recovered contains at least about 60 wt %, at least about 65 wt %, at least about 70 wt %, at least about 75 wt %, at least about 80 wt %, at least about 85 wt %, at about 90 wt %, or greater than about 95 wt % protein (N×6.25) d.b.; and/or
the concentration step is effected at generally about 2° C. to about 65° C., preferably about 50° C. to about 60° C.

27. (canceled)

28. The process of claim 1, wherein in step f):
the diafiltration water is not pH adjusted or the water is adjusted with any food grade acid to a pH down to that of the optionally concentrated sunflower protein solution, or the diafiltration is done in stages using water at different pH values, preferably initial volumes of diafiltration using water adjusted to the pH of the protein solution followed by additional volumes of diafiltration using water without pH adjusting agent; and/or
diafiltration is effected using from about 0.5 to about 40 volumes of diafiltration solution, preferably about 2 to about 25 volumes of diafiltration solution, more preferably about 2 to about 5 volumes of diafiltration solution; and/or
diafiltration is effected using the same membrane as for the concentration step e) or the diafiltration is effected using a separate membrane with a different molecular weight cut-off, such as a membrane having a molecular weight cut-off in the range of about 1,000 to about 1,000,000 daltons, preferably about 1,000 to about 100,000 daltons, more preferably about 10,000 to about 100,000 daltons; and/or
the diafiltration water comprises an antioxidant, such as ascorbic acid, optionally in an amount of from about 0.01 to about 1 wt %, preferably about 0.05 to about 0.15 wt %, more preferably about 0.05 to about 0.10 wt %; and/or
the diafiltration step is effected in such a manner that the sunflower protein product subsequently recovered contains at least about 60 wt %, at least about 65 wt %, at least about 70 wt %, at least about 75 wt %, at least about 80 wt %, at least about 85 wt %, at about 90 wt %, or greater than about 95 wt % protein (N×6.25) d.b.; and/or
the diafiltration is effected at generally about 2° C. to about 65° C., preferably about 50° C. to about 60° C.

29. (canceled)

30. (canceled)

31. (canceled)

32. (canceled)

33. (canceled)

34. (canceled)

35. The process of claim 1, wherein:
the optionally concentrated and optionally diafiltered protein solution are subject to a further defatting step; and/or
the optionally concentrated and optionally diafiltered protein solution is treated with an adsorbent, such as granulated activated carbon, to remove colour and/or odour compounds; and/or
the optionally concentrated and optionally diafiltered protein solution is pasteurized prior to optional drying or further processing and wherein pasteurization optionally comprises heating the optionally concentrated and optionally diafiltered sunflower protein solution to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° C. to about 35° C.; and/or
the optionally concentrated and optionally diafiltered acidified sunflower protein solution is jet cooked to a temperature of about 110° C. to about 150° C. for a time of about 10 seconds to about 1 minute, preferably about 140° C. to about 145° C. for about 40 to about 50 seconds, prior to optional drying step (a).

36. (canceled)

37. The process of claim 1, wherein step e) and/or f) are carried out and:
the partially concentrated, concentrated and/or diafiltered acidified sunflower protein solution is subjected to a heat treatment step to at least partially inactivate heat-labile anti-nutritional factors including heat-labile trypsin inhibitors, optionally wherein:
the heat treatment step is effected to pasteurize the partially concentrated, concentrated and/or diafiltered acidified aqueous protein solution; and/or
the heat treatment is effected at a temperature and for a time selected from the group consisting of about 70° C. to about 160° C. for about 10 seconds to about 60 minutes, about 80° C. to about 120° C. for about 10 seconds to about 5 minutes and about 85° C. to about 95° C. for about 30 seconds to about 5 minutes; and/or
the heat treated sunflower protein solution is cooled to a temperature selected from the group consisting of about 2° C. to about 65° C. and about 50° C. to about 60° C.; and/or
the concentration and/or diafiltration steps are operated in a manner favourable for removal of trypsin inhibitors in the permeate, optionally by using a membrane of larger molecular weight cut-off, such as 30,000 to 1,000,000 Da, operating the membrane at elevated temperatures, such as about 30° C. to about 65° C., preferably about 50° C. to about 60° C., and employing greater volumes of diafiltration medium, such as 10 to 40 volumes; and/or
the partially concentrated, concentrated and/or diafiltered acidified sunflower protein solution is subjected to drying step (g) to provide a sunflower protein isolate having a protein content of at least about 60 wt %, at least about 65 wt %, at least about 70 wt %, at least about 75 wt %, at least about 80 wt %, at least about 85 wt %, at least about 90 wt %, or greater than about 95 wt % protein (N×6.25) d.b.

38. (canceled)

39. (canceled)

40. (canceled)

41. (canceled)

42. (canceled)

43. (canceled)

44. (canceled)

45. (canceled)

46. (canceled)

47. The process of claim 1, wherein the pH of the optionally concentrated and optionally diafiltered acidified sunflower protein solution is raised to a value selected from the group consisting of less than about 8.0, about 6.0 to about 8.0 and about 6.5 to about 7.5, to produce a pH adjusted sunflower protein solution, prior to optional drying step (g), optionally wherein:
the pH adjusted sunflower protein solution is further membrane processed such as concentrated and/or diafiltered prior to optional drying step (g), optionally wherein:
the membrane processed pH adjusted sunflower protein solution is jet cooked to a temperature of about 11000 to about 150° C. for a time of about 10 seconds to about 1 minute, preferably about 140° C. to about 145° C. for about 40 to about 50 seconds, prior to optional drying step (g); and/or
the membrane processed pH adjusted sunflower protein solution is pasteurized prior to optional drying and wherein pasteurization optionally comprises heating the sunflower protein solution to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° C. to about 35° C.; and/or
the pH adjusted sunflower protein solution is jet cooked to a temperature of about 110° C. to about 150° C. for a time of about 10 seconds to about 1 minute, preferably about 140° C. to about 145° C. for about 40 to about 50 seconds, prior to optional drying step (q); and/or
the pH adjusted sunflower protein solution is pasteurized prior to optional drying and wherein pasteurization optionally comprises heating the sunflower protein solution to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, and optionally the pasteurized sunflower protein solution is cooled, such as to a temperature of about 20° to about 35° C.; and/or
a food grade sodium hydroxide, potassium hydroxide or any other conventional food grade alkali and combinations thereof are added to the optionally concentrated and optionally diafiltered acidified sunflower protein solution to raise the PH.

48. (canceled)

49. (canceled)

50. (canceled)

51. (canceled)

52. (canceled)

53. The process of claim 1, wherein the finer residual solids are captured separately from the bulk of the separated residual sunflower protein source in step b), optionally by the disc stack centrifuge, then:
are optionally diluted with water, optionally RO water, then optionally dried to form a sunflower protein product having a protein content of at least about 45 wt % (N×6.25) d.b., preferably at least about 50 wt % (N×6.25) d.b., more preferably at least about 55 wt % (N×6.25) d.b., and even more preferably at least about 60 wt % (N×6.25) d.b., optionally wherein:
the optionally diluted finer residual solids are pasteurized prior to the optional drying step, wherein Pasteurization optionally comprises heating to a temperature of about 55° C. to about 85° C. for about 10 seconds to about 60 minutes, Preferably about 60° C. to about 70° C. for about 10 minutes to about 60 minutes or about 70° C. to about 85° C. for about 10 seconds to about 60 seconds, optionally wherein the pasteurized optionally diluted finer residual solids are cooled, such as to a temperature of about 20° C. to about 35° C., or
are optionally diluted with water, optionally RO water, then are adjusted to a value between about pH 6.0 and about 8.0, by any conventional means such as by the addition of sodium hydroxide, potassium hydroxide or any other conventional food grade alkali and combinations thereof, or hydrochloric acid, phosphoric acid, citric acid or any other conventional food grade acid and combinations thereof, prior to optional drying to form a sunflower protein product having a protein content of at least about 45 wt % (N×6.25) d.b., preferably at least about 50 wt % (N×6.25) d.b., more preferably at least about 55 wt % (N×6.25) d.b., and even more preferably at least about 60 wt % (N×6.25) d.b., optionally wherein:
the optionally diluted and pH adjusted finer residual solids are pasteurized prior to the optional drying step, wherein pasteurization optionally comprises heating to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, optionally wherein the pasteurized optionally diluted and pH adjusted finer residual solids are cooled, such as to a temperature of about 20° C. to about 35° C.

54. (canceled)

55. The process of claim 1, wherein the finer residual solids are captured separately from the bulk of the separated residual sunflower protein source in step b), optionally by the disc stack centrifuge, are washed in order to remove contaminants and improve the purity and flavour of the product, optionally by suspending the solids in between about 1 and about 20 volumes, preferably about 1 to about 10 volumes of wash solution such as water, preferably RO water, and optionally the washing step is conducted at any conventional temperature such as about 15° C. to about 65° C., preferably about 50° C. to about 60° C., and optionally for any conventional length of time, preferably 15 minutes or less, then a separation step is performed by any conventional means such as by centrifugation using a disc stack centrifuge to provide washed finer residual solids and a used wash solution.

56. The process of claim 55, wherein:
the separated used wash solution is added to the aqueous sunflower protein solution arising from the separation step b) or to the optionally concentrated and optionally diafiltered acidified sunflower protein solution for further processing, optionally wherein the separated used wash solution is defatted before addition to the aqueous sunflower protein solution or to the optionally concentrated and optionally diafiltered acidified sunflower protein solution; and/or
the washed finer residual solids are optionally diluted with water then optionally dried by any conventional means such as spray drying or freeze drying to provide a sunflower protein product having a protein content of at least about 45 wt % (N×6.25) d.b., preferably about 50, 55, 60 or 65 wt % (N×6.25) d.b., more preferably about 70 wt % (N×6.25) d.b., optionally wherein:
the optionally diluted washed finer residual solids are pasteurized prior to the optional drying step, wherein pasteurization optionally comprises heating to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, optionally wherein the pasteurized optionally diluted washed finer residual solids are cooled, such as to a temperature of about 20° C. to about 35° C., or
the washed finer residual solids are optionally diluted with water then the pH of the optionally diluted washed finer residual solids is adjusted to a value between about 6.0 and about 8.0, by any conventional means such as by the addition of sodium hydroxide, potassium hydroxide or any other conventional food grade alkali and combinations thereof, or hydrochloric acid, phosphoric acid, citric acid or any other conventional food grade acid and combinations thereof, prior to optional drying, optionally wherein:
the optionally diluted pH adjusted washed finer residual solids are pasteurized prior to the optional drying step, wherein pasteurization optionally comprises heating to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, optionally wherein the pasteurized optionally diluted pH adjusted washed finer residual solids are cooled, such as to a temperature of about 20° C. to about 35° C.; or
the finer residual solids are pH adjusted during the washing step by adjusting the mixture of finer residual solids and wash water to a pH between about 6.0 to about 8.0 using food grade alkali or acid solution, then collecting the solids by centrifugation and optionally diluting the solids with water and optionally drying the solids, optionally wherein:
the optionally diluted pH adjusted washed finer residual solids are pasteurized prior to the optional drying step, wherein pasteurization optionally comprises heating to a temperature of about 55° C. to about 85° C. for about 10 seconds to about 60 minutes, preferably about 60° C. to about 70° C. for about 10 minutes to about 60 minutes or about 70° C. to about 85° C. for about 10 seconds to about 60 seconds, optionally wherein the pasteurized optionally diluted pH adjusted washed finer residual solids are cooled, such as to a temperature of about 20° C. to about 35° C.

57. (canceled)

58. (canceled)

59. (canceled)

60. (canceled)

61. (canceled)

62. (canceled)

63. The process of claim 1, wherein the coarse residual solids are captured separately from the finer residual solids of the separated residual sunflower protein source in step b), optionally wherein:
the coarse residual solids are captured by the decanter centrifuge, are optionally diluted with water, optionally RO water, optionally pasteurized then optionally dried to form a sunflower protein product having a protein content of at least about 25 wt % (N×6.25) d.b., preferably at least about 30, 35, 40, 45, 50 or 55 wt % (N×6.25) d.b., more preferably at least about 60 wt % (N×6.25) d.b.; and/or
the finer residual solids are optionally washed, then the coarse residual solids and the optionally washed finer residual solids are combined for optional dilution with water, optional pasteurization and optional drying to form a sunflower protein product having a protein content of at least about 40 wt % (N×6.25) d.b., preferably at least about 45, 50 or 55 wt % (N×6.25) d.b., more preferably at least about 60 wt % (N×6.25) d.b.

64. (canceled)

65. (canceled)

66. (canceled)

67. (canceled)

68. A sunflower protein product having one or more of the following attributes:
(i) a protein content of at least about 65, at least about 70, at least about 75, at least about 80, at least about 85, at least about 90, or at least about 95 wt % (N×6.25) d.b., which has a protein solubility of less than 30% when measured at pH 4, less than about 20% when measured at pH 5.5 and less than 40% when measured at pH 7, optionally wherein the protein solubility is of 4.8-21.3% when measured at pH 4, 3.5-17.6% when measured at pH 5.5 and 7.3-36.6% when measured at pH 7, optionally wherein the protein solubility is 8.1-19.3% when measured at pH 4, 3.5-12.0% when measured at pH 5.5 and 11.8-27.2% when measured at pH 7;
(ii) a protein content of at least about 65, at least about 70, at least about 75, at least about 80, at least about 85, at least about 90, or at least about 95 wt % (N×6.25) d.b., which has a dry colour L* value of about 52.54 to about 84.18, a dry colour a* value of about −1.99 to about 4.31, and a dry colour b* value of about 11.27 to 21.90;
(iii) a dry colour L* value of about 80.69 to about 84.18, a dry colour a* value of about −1.05 to about 0.50, and a dry colour b* value of about 11.27 to 17.24; or a dry colour L* value of about 80.69 to about 83.40, a dry colour a* value of about −0.24 to about 0.50, and a dry colour b* value of about 11.60 to 14.50;
(iv) a viscosity for a 10% protein solution tested at a shear rate of 1.28 (1/s) of less than about 30 mPa-s or about 19.3 to about 28.8 mPa-s;
(v) a phytic acid content greater than about 6 wt % on a dry basis, or a phytic acid content of between 6.16 and 7.03 wt % on a dry basis;
(vi) a sodium content of between about 0.2 and about 0.3 wt % on a dry basis, optionally wherein the sunflower protein product has a protein content of between 47.13 and 53.24 wt % (N×6.25) d.b.;
(vii) a water binding capacity as defined in or captured by Table 5;
(viii) an oil binding capacity as defined in or captured by Table 6; and/or
(ix) an acid hydrolysis fat content as defined in or captured by Table 12,
optionally wherein the sunflower protein product is derived from: confectionery or non-oilseed or black oil or oilseed or conoil sunflower seed; dehulled sunflower seed; or a partially or fully defatted sunflower protein source.

69. (canceled)

70. (canceled)

71. (canceled)

72. (canceled)

73. (canceled)

74. A sunflower protein product having an amino acid profile comprising:

| amino acid | concentration (mg/g protein) |
|---|---|
| Threonine | about 31.4 to about 44.3 |
| Valine | about 43.3 to about 54.8 |
| Isoleucine | about 36.6 to about 48.2 |
| Leucine | about 54.5 to about 75.5 |
| Tyrosine | about 23.4 to about 36.2 |
| Phenylalanine | about 39.3 to about 61.6 |
| Lysine | about 27.2 to about 41.0 |
| Histidine | about 23.6 to about 33.3 |
| Cysteine | about 14.2 to about 23.4 |
| Methionine | about 16.6 to about 33.1 |
| Tryptophan | about 10.6 to about 12.2 |

optionally wherein the sunflower protein product has an amino acid profile comprising:

| amino acid | concentration (mg/g protein) |
|---|---|
| Threonine | about 31.4 to about 44.3 |
| Valine | about 43.3 to about 54.8 |
| Isoleucine | about 36.6 to about 48.2 |
| Leucine | about 54.5 to about 75.5 |
| Tyrosine | about 25.7 to about 36.2 |
| Phenylalanine | about 46.1 to about 61.6 |
| Lysine | about 27.2 to about 38.0 |
| Histidine | about 23.8 to about 33.3 |
| Cysteine | about 14.2 to about 23.4 |
| Methionine | about 22.9 to about 33.1 |
| Tryptophan | about 10.6 to about 12.2 |

optionally wherein the sunflower protein product has an amino acid profile comprising:

| amino acid | concentration (mg/g protein) |
|---|---|
| Threonine | about 41.6 to about 44.3 |
| Valine | about 52.8 to about 54.8 |
| Isoleucine | about 46.6 to about 48.2 |
| Leucine | about 73.1 to about 75.5 |
| Tyrosine | about 35.0 to about 36.2 |
| Phenylalanine | about 59.3 to about 61.6 |
| Lysine | about 34.9 to about 38.0 |
| Histidine | about 31.3 to about 33.3 |
| Cysteine | about 22.6 to about 23.4 |
| Methionine | about 29.6 to about 33.1 |
| Tryptophan | about 11.0 to about 11.8 |

optionally wherein the sunflower protein product is derived from: confectionery or non-oilseed or black oil or oilseed or conoil sunflower seed: dehulled sunflower seed: or a Partially or fully defatted sunflower protein source.

75. (canceled)

76. (canceled)

77. A sunflower protein product having a chlorogenic acid content of about 56 to about 226 ppm on a dry basis,
optionally wherein the sunflower protein product is derived from: confectionery or non-oilseed or black oil or oilseed or conoil sunflower seed: dehulled sunflower seed: or a partially or fully defatted sunflower protein source.

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. A food or beverage comprising a sunflower protein product of claim 68, optionally wherein the food or beverage is:
a) a dairy alternative, optionally selected from a milk alternative beverage, a frozen dessert, a cheese alternative or a yogurt alternative;
b) a meat alternative, optionally selected from a beef alternative, a pork alternative or a poultry alternative;
c) a seafood alternative, optionally selected from a tuna alternative, a salmon alternative or a shrimp alternative;
d) a grain product, optionally selected from a pasta, a bread or a breakfast cereal;
e) a snack or sweet, optionally selected from a cookie, a cracker, a bar product or a cake;
f) a fats and oils product, optionally selected from a margarine or a dressing;
g) a condiment or sauce, optionally selected from a tomato-based sauce, a non-tomato-based sauce, a dip or a gravy: or
h) a nutritional product, optionally selected from a nutritional drink or a nutritional powder, wherein the food or beverage is optionally selected from a sports drink, an energy drink or a smoothie.

91. (canceled)

92. (canceled)

93. (canceled)

94. (canceled)

95. (canceled)

96. (canceled)

97. (canceled)

98. (canceled)

99. (canceled)
